(19) United States
(12) Patent Application Publication
(10) Pub. No.: US 2026/0300000 A1
(43) Pub. Date: Oct. 1, 2026

(54) Control Running Concurrent Threads for an Application

(71) Applicant: Micron Technology, Inc., Boise, ID (US)

(72) Inventors: Kamil Khan, Folsom, CA (US); Poorna Kale, Folsom, CA (US)

(21) Appl. No.: 19/092,644

(22) Filed: Mar. 27, 2025

(51) Int. Cl. G06F 9/48; G06F 9/50; G06F 11/34; G06F 13/16; G06N 3/092

(52) U.S. Cl. CPC G06F 9/4881; G06F 9/5016; G06F 11/3404; G06F 11/3409; G06F 13/1657; G06N 3/092; G06F 2213/0026

(57) ABSTRACT

A method including: determining a first state of an application running in a computing system, the first state indicating memory resources available to the application; identifying, based on the first state, a first adjustment to a policy configured to control instantiation of threads for the application; instantiating, according to the policy as adjusted by the first adjustment, a plurality of threads to run in parallel in the computing system; assigning a plurality of tasks to the plurality of threads; and distributing, based on the policy as adjusted by the first adjustment, the memory resources to the plurality of threads to perform the plurality of tasks.

### TECHNICAL FIELD

At least some embodiments disclosed herein relate to memory systems in general and, more particularly but not limited to, memory accessed via compute express link connections.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 to FIG. 4 show techniques to provide a secondary tier memory according to some embodiments.

FIG. 5 shows a compute express link fabric configured to provide a secondary tier memory according to one embodiment.

FIG. 6 shows the attaching of dynamic capacity devices over a compute express link fabric to provide a random access memory according to one embodiment.

FIG. 7 shows a mapped memory space implemented via a compute express link fabric to provide a dynamically adjustable random access memory according to one embodiment.

FIG. 8 illustrates a controller of a compute express link (CXL) fabric caching portions of memory sub-systems in the memory space provided by memory devices connected to the fabric according to one embodiment.

FIG. 9 shows a compute express link switch configured to implement a dynamically adjustable random access memory according to one embodiment.

FIG. 10 illustrates a reinforcement learning technique to manage allocation of memory to threads of an application according to one embodiment.

FIG. 11 and FIG. 12 show examples of adjustments to policies of memory allocation according to some embodiments.

FIG. 13 shows an example of state parameters for a reinforcement learning agent to select parameters used in implementing requested memory according to one embodiment.

FIG. 14 shows an example of memory usage statistics that can be used as part of state parameters for implementation of requested memory according to one embodiment.

FIG. 15 shows a method to implement memory according to one embodiment.

FIG. 16 illustrates a reinforcement learning technique to manage the configuration of running concurrent threads for an application according to one embodiment.

FIG. 17 shows a method to optimize performance of an application according to one embodiment.

FIG. 18 shows an example of state parameters for a reinforcement learning agent to select adjustments to a thread configuration of an application according to one embodiment.

FIG. 19 shows an example of runtime memory metrics that can be used as part of state parameters for control running thread for an application according to one embodiment.

FIG. 20 shows an example of task characteristics that can be used as part of state parameters for control running thread for an application according to one embodiment.

FIG. 21 shows a technique to control memory allocations of concurrent threads of an application according to one embodiment.

FIG. 22 shows a method to control running concurrent threads for an application according to one embodiment.

FIG. 23 is a block diagram of an example computer system in which embodiments of the present disclosure can operate.

### DETAILED DESCRIPTION

Different workloads can have different demands on memory resources. Without explicit information about workloads, memory resources in a computing system can be inadequately configured, causing over-provisioning in some aspects and/or under-provisioning in other aspects.

At least some aspects of the present disclosure address the above and other deficiencies and challenges by implementing a random access memory via a compute express link (CXL) fabric to a host processor, where at least some aspects (e.g., capacity, bandwidth, latency, power consumption level) of the random access memory can be defined and/or adjusted via software running in the host processor.

Dynamic capacity devices (DCDs) are logical memory devices supported by a standard of compute express link (CXL), where the capacity of a dynamic capacity device attached via compute express link (CXL) to a host system can be adjusted or changed without restarting the host system and/or without restarting the computing system containing the host system and the memory device.

In at least some embodiments disclosed herein, a host system can dynamically request changes in characteristics/attributes of the random access memory attached to the host system via CXL connections without restarting. Such characteristics/attributes can include capacity, bandwidth, latency, or power consumption level, or any combination thereof.

For example, the random access memory of a host processor can be implemented via a set of dynamic capacity devices offered by a plurality of memory devices of different characteristics, such as bandwidth, latency, power consumption level, etc. The dynamic capacity devices are attached to the host processor at the time of booting up the computing system containing the host processor and the memory devices. The capacity sizes of the dynamic capacity devices can be adjusted at the run time of the host processor without restarting.

By requesting the memory devices to change the capacity sizes of the dynamic capacity devices, the host processor can dynamically change the ratio of memory resources allocated from the memory devices of different characteristics to implement the random access memory of the host processor. Changing the memory resource allocation ratio can change the characteristics/attributes of the random access memory attached to the host processor.

For example, the host processor can determine the desirable characteristics/attributes of the random access memory based on the requirements or demands of the applications running in the host processor. The host processor can request changes in the capacity sizes of the dynamic capacity devices in a way such that the random access memory has characteristics/attributes that meet the requirements or demands of the applications.

Dynamic capacity devices offered by memory devices connected to a CXL fabric have performance levels of the respective memory devices in servicing a host processor over the fabric. For example, due to the connection topology and/or the differences in the memory devices as manufactured, the memory devices can have different performance levels in bandwidth, latency, and/or power consumption in servicing the host processor over the CXL fabric. Changing the distribution of capacity sizes across the dynamic capacity devices attached to the host processor can change various aspects (e.g., capacity, bandwidth, latency, power consumption level) of the random access memory implemented using the dynamic capacity devices.

In some implementations, the CXL fabric is configured to allocate memory resources from memory devices connected to the CXL fabric to implement logical memory devices attached to host processors. For example, the logical memory devices can be offered by the CXL fabric in a form of dynamic capacity devices that are attached to the host processors during the boot up time. The CXL fabric can dynamically change the mapping of memory addresses in the logical memory devices to the memory resources allocated from the memory devices to change the aspects (e.g., capacity, bandwidth, latency, power consumption level) of the local memory devices offered by the CXL fabric to the host processors.

In general, a set of compute express link (CXL) connections, a CXL switch, and/or a CXL fabric containing one or more CXL switches interconnected by CXL connections can be used to connect a plurality of memory devices to one or more host processors, such as a central processing unit (CPU), a graphical processing unit (GPU), a system on a chip (SoC), an artificial intelligence (AI) accelerator, etc. Each of the memory devices and/or a controller of the CXL fabric can offer a plurality of dynamic capacity devices. Each of the dynamic capacity devices can be attached to a host processor such that the host processor has a secondary tier of memory that is dynamically adjustable in various aspects, such as capacity, bandwidth, latency, power efficiency, etc.

A plurality of dynamic capacity devices can be attached to a host processor during the boot time of the computing system. The dynamic capacity devices provide a secondary tier memory for the host processor. The host processor can adjust the nominal performance levels of the secondary tier memory in capacity, bandwidth, latency, power efficiency, etc. by requesting changes in the capacity sizes of the dynamic capacity devices. When a dynamic capacity device is offered by the controller of the CXL fabric, the host processor can request the controller to implement the dynamic capacity device according to a performance level specified by the host processor. The plurality of dynamic capacity devices as a whole can provide the secondary tier memory to supplement the primary tier memory of the host processor (e.g., the main memory connected to the host processor via a memory bus, such as a double data rate bus).

Due to the differences in the memory devices and/or their locations in the network of CXL connections from the memory devices to the host processor, the plurality of dynamic capacity devices offered by the memory devices can have different performance levels in bandwidth, latency, and/or power consumption. The host processor can determine a combination of capacity sizes of the dynamic capacity devices such that the secondary tier memory has performance levels in capacity, bandwidth, latency, and/or power consumption that meet, or approximately match with (e.g., in average over time), a memory configuration requirement identified by the host processor for the applications running in the host processor.

Other dynamic capacity devices can be attached over the CXL connections, switch and/or fabric to one or more other host processors to service their applications.

Since the capacity of each dynamic capacity device attached to a host processor can be changed dynamically without restarting, and the characteristics of logical memory devices implemented by the controller of the CXL fabric can change without restarting, a software component running in the host processor can determine and adjust the ratio of capacity distribution across the dynamic capacity devices that are attached to the host processor, such that the average performance level of the random access memory, implemented as the secondary tier memory using the dynamic capacity devices, matches with or satisfies a memory performance target of one or more applications currently running in the host processor.

By tweaking the distribution of capacity sizes across the dynamic capacity devices attached to a host processor, the host processor can effectively allocate, over a CXL switch or fabric, a random access memory having a target performance level needed for the applications currently running in the host processor. The random access memory can have a capacity, bandwidth, latency, and/or power consumption level defined or requested by a software component (e.g., an operating system or a hypervisor) running in the host processor. Customization of characteristics of the random access memory used by the host processor over the CXL switch or fabric as a secondary tier memory can be performed on-demand and at a runtime of applications without hardware changes.

The memory resources connected to the CXL switch or fabric but not used by the host processor can be allocated and used by one or more other host processors connected to the CXL switch or fabric. Different host processors can have their respective secondary tier memory of different characteristics (e.g., capacity, bandwidth, latency, and/or power consumption), implemented using different portions of the same set of physical memory devices connected to the CXL switch or fabric.

For example, a software component (e.g., an operating system or a hypervisor) running in the host processor can define the capacity of the secondary tier memory (e.g., the total amount of data that can be stored in the secondary tier memory). When the applications running in the host processor needs more memory, the software component can request one or more of the dynamic capacity devices attached to the host processor to increase capacity; and when the applications running in the host processor finishes using the memory, the software component can return the excessive memory by requesting the one or more dynamic capacity devices to decrease capacity.

For example, a software component (e.g., an operating system or a hypervisor) running in the host processor can identify the bandwidth of the secondary tier memory (e.g., the rate at which the secondary tier memory can read or write data) to support the applications running in the host processor. Depending on the topology of the CXL network and the location of the dynamic capacity devices, different memory regions on the CXL network can be accessed by the host processor with different memory bandwidth levels, even when each memory device has a same memory bandwidth when the memory device is used in a direct connection. The availability of communication bandwidths in the CXL network and/or real time communication traffic pattern in the CXL network can limit the memory bandwidth of a memory device in serving the host processor. For example, a dynamic capacity device can be attached directly to a host through one or more CXL/PCI lanes for an increased bandwidth, or through one or more CXL switches over a network of CXL connections shared by different host processors and/or memory devices for a reduced bandwidth. Depending on application requirements, the software component running in the host processor can decide how to make capacity adjustments to the dynamic capacity devices to meet a memory bandwidth requirement (or an average memory bandwidth target).

For example, a component running in the host processor can identify the latency of the secondary tier memory (e.g., the delay between a memory request sent from a processor and a response received in the processor in response to the request) to support the applications running in the host processor. The latency of a dynamic capacity device connected via one or more compute express link (CXL) connections (e.g., connected directly or through one or more CXL switches) can be dependent on the overhead in communications over the CXL connections, runtime sharing of CXL connections, communications traffic conditions, and the latency of the memory device responding to a request. The software component running in the host processor can select capacity adjustment requests for the dynamic capacity devices attached to the host processor such that the secondary tier memory meets a latency requirement (or an average memory latency), in view of the various factors that can impact the latency of the secondary tier memory.

For example, a software component running in the host processor can identify a desirable power consumption level of the secondary tier memory for the secondary tier memory. Different dynamic capacity devices can have different power profiles. Depending on the cost goals of a computing system and/or applications, the software can power-down power-hungry memory devices connected to the CXL fabric to reduce memory power consumption, and utilize power-efficient memory devices at an acceptable level of performance degradation.

A software layer can be configured to implement tiering management across kernel-space and/or user-space. The software layer can manage (e.g., based on memory access patterns) the placement and movement of memory pages in and among the primary tier memory (e.g., the main memory provided over a memory bus, such as a double data rate (DDR) memory bus) and the secondary tier memory (e.g., memory devices connected over one or more compute express link connections over one or more peripheral component interconnect express (PCIe) buses). The operations of the software layer running in the host processor to move memory pages can significantly degrade the application performance due to the active demotion of cold memory pages to the slower memory, and subsequent accesses to cold memory pages. A memory page that has not been accessed for a period of time can be considered a cold memory page; and the length of a continuous time period in which a memory page has not being access can be an indicator of a temperature of the memory page; a longer length corresponding to a colder page.

Tiering management can be implemented via hardware in the memory system, instead of via a host processor running a software layer. When tiering management is implemented solely in memory hardware, the configuration of the tiered memory cannot be changed without significant changes at different levels in the hardware and software stack.

In general, the bandwidth of a random access memory provided over one or more compute express link (CXL) connections to a host processor can be dependent on several factors: the number of parallel CXL paths between the random access memory and the host processor, the switching topology of a CXL fabric coupled between the random access memory and the host processor, the efficiency of each CXL switch in the CXL fabric, real time traffic load in the CXL fabric, the latency of the memory media, etc.

In some embodiments disclosed herein, a software technique is used to allocate the memory bandwidth required for applications during runtime.

For example, a fabric manager can be configured as a software component running in a CXL fabric (e.g., in a controller of the CXL fabric, or as a set of agents running in the CXL switches of the fabric). A host processor (e.g., a central processing unit (CPU), a graphical processing unit (GPU), a system on a chip (SoC)) connected to the CXL fabric can specify a memory configuration requirement for a random access memory attached via the CXL fabric to the host processor. For example, the memory configuration requirement can specify a requested capacity, a requested bandwidth, and/or a requested latency of the random access memory. The fabric manager can allocate communication resources of the CXL fabric and memory resources of memory devices connected to the CXL fabric to implement a random access memory that has an implemented memory configuration that is closest to the requested memory configuration.

For example, the distance between the implemented memory configuration and the requested memory configuration can be based on a cartesian distance in a memory characteristic space having independent axes in capacity, latency, bandwidth, and/or power efficiency. A requested memory configuration is represented by a point in the memory characteristics space having coordinates represented by the requested capacity, latency, bandwidth, and/or power efficiency. An implemented memory configuration is represented by a point in the memory characteristics space having coordinates represented by the implemented capacity, latency, bandwidth, and/or power efficiency. The cartesian distance between the two points in the memory characteristic space can be minimized or reduced to find an implementation that substantially meets the requirements of the requested memory configuration.

In some implementations, the memory characteristic space is configured based on normalized memory parameters, such as normalized capacity, normalized latency, normalized bandwidth, and/or normalized power efficiency level. For example, the memory characteristic parameters (e.g., capacity, latency, bandwidth, power efficiency level) can be normalized with respect to the corresponding parameters specified in the memory configuration request, or normalized using a set of predetermined parameters (e.g., reference capacity, reference latency, reference bandwidth, reference power efficiency level). Optionally, the normalized parameters can be further weighted according to importance of the respective parameters (e.g., capacity, latency, bandwidth, power efficiency) for the applications running in the host processor.

In some implementations, the fabric manager is configured with a look up table to map the memory addresses identified by the host processor in memory access requests to physical memory addresses of random access memory cells in memory devices connected to the CXL fabric. Through the mapping implemented using the look up table, the memory access requests received in the CXL fabric from the processor can be routed via the CXL fabric to the corresponding memory devices from which the memory resources are allocated to implement the secondary tier random access memory attached to the host processor via the CXL fabric.

Optionally, the fabric manager can continuously or periodically update the look up table used to implement the random access memory attached to the processor to account for runtime variation in memory characteristics such as bandwidth and latency. Optionally, the fabric manager can monitor the deviation of the memory characteristics (e.g., bandwidth, latency) from the requirements specified by the host processor, and update the look up table to reduce or eliminate the differences from the requirements in response to a determination that the deviation exceeds a predefined threshold.

In one implementation, during an initialization phase of attaching the secondary tier memory to a host processor for random access over a CXL fabric, each of the memory devices connected to the CXL fabric can have a small portion of its entire capacity allocated to implement the secondary tier memory. The host processor can run a synthetic workload to determine the observed characterizes (e.g., bandwidth, latency) of each memory allocation. Each memory device connected to the CXL fabric can identify its size of entire capacity to the fabric manager. During the runtime phase of the processor using the random access memory, the memory devices connected to the CXL fabric can send metadata to the fabric manager to indicate the observed latency to the host processor. Based on the measured latency and bandwidth, the fabric manager can adjust the portion sizes of memory resource allocation from the memory devices to implement the random access memory in a way that meets the memory configuration requirement identified the processor and/or reduce the differences between the memory configuration as implemented via the CXL fabric and the memory configuration as requested by the host processor.

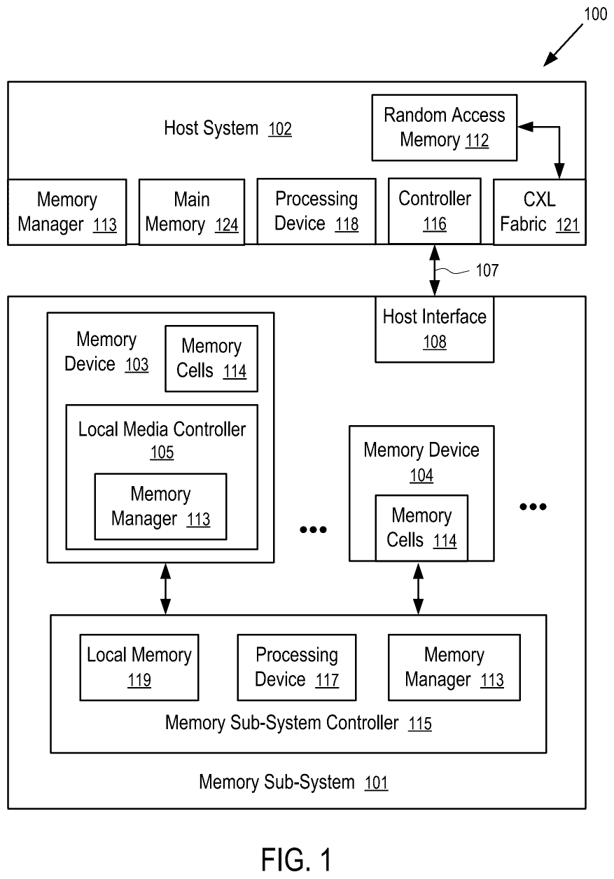

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a memory manager 113 configured to perform operations related to the management of the characteristics of a random access memory 112 attached to the processing device 118 of the host system 102 via a compute express link (CXL) fabric 121. Such characteristics can include capacity, bandwidth, latency, and/or power consumption level. In some embodiments, the controller 115 in the memory sub-system 101 includes at least a portion of the memory manager 113. In other embodiments, or in combination, the fabric 121, the controller 116 and/or the processing device 118 in the host system 102 can include at least a portion of the memory manager 113. For example, the fabric 121, the controller 115, the controller 116, and/or the processing device 118 can include logic circuitry implementing the memory manager 113. For example, the switches and/or controller of the fabric 121, the controller 115, or the processing device 118 (processor) of the host system 102, can be configured to execute instructions stored in memory for performing the operations of the memory manager 113 described herein. In some embodiments, the memory manager 113 is implemented in an integrated circuit chip disposed in the memory sub-system 101 or a controller of the fabric 121. In other embodiments, the memory manager 113 can be part of firmware of the memory sub-system 101, an operating system of the host system 102, a device driver, a set of agents running in CXL switches of the fabric 121, a part of a fabric manager running a controller of the CXL fabric 121, or an application, or any combination thereof.

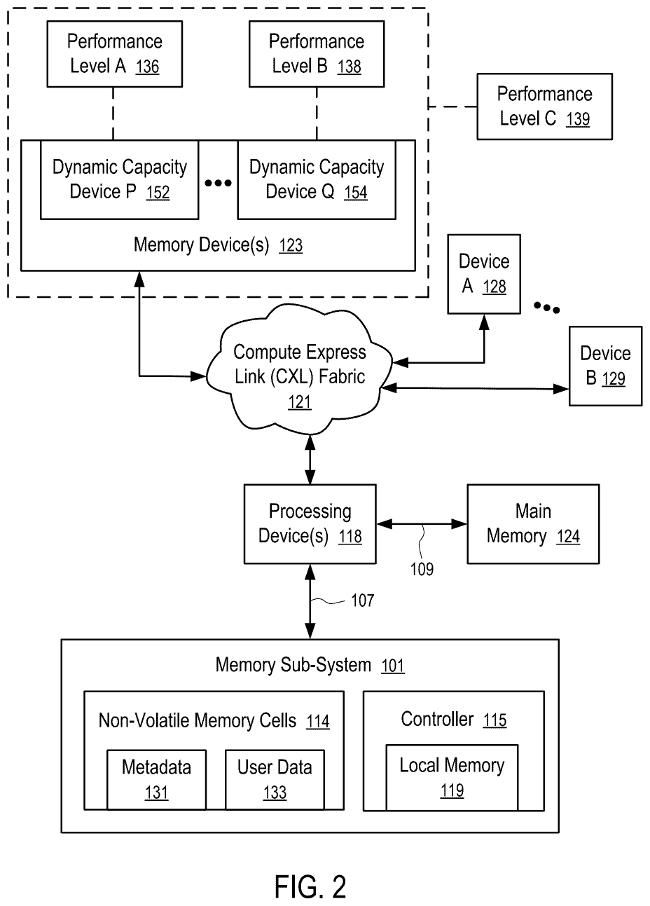

The random access memory 112 can be implemented using resources allocated from a plurality of memory devices 123 attached to the CXL fabric 121 as in FIG. 2 to FIG. 4. For example, the memory devices 123 can offer dynamic capacity devices (e.g., 152, . . . , 154) that can be attached to a host processor (e.g., processing device 118) to provide a secondary tier memory for the host processor to supplement the main memory 124 of the host system 102. The memory manager 113 can be configured to request the dynamic capacity devices (e.g., 152, . . . , 154) to change their capacity sizes a run time to effectively change the characteristics (e.g., capacity, bandwidth, latency, power consumption) of the random access memory 112 functioning as the secondary tier memory. Optionally, the memory manager 113 implemented in the fabric 121 can use a look up table to map addresses used by the processing device 118 in memory access requests into addresses in the memory devices 123. The memory access requests are routed through the fabric 121 according to the look up table/address mapping. The memory manager 113 can change the characteristics (e.g., capacity, bandwidth, latency, power consumption) of the random access memory 112 through dynamically changing the look up table without restarting the computing system 100 and/or the host system 102.

FIG. 2 to FIG. 4 show techniques to provide a secondary tier memory according to some embodiments. For example, the techniques of FIG. 2 to FIG. 4 can be implemented in the computing system 100 of FIG. 1 to provide the random access memory 112 over the CXL fabric 121.

In FIG. 2 to FIG. 4, a compute express link (CXL) fabric 121 is configured to provide a random access memory (e.g., 112) using a set of memory devices 123 having random access memory cells that are addressable using physical memory addresses in the memory devices 123.

For example, the compute express link (CXL) fabric 121 can include a set of CXL switches interconnected via CXL connections and controlled at least in part by a controller. The memory devices 123 are connected to the switches in the fabric 121 via point to point CXL connections; and the controller of the CXL fabric 121 is configured to direct how memory access communications are routed by the CXL switches through the fabric 121 to or from the memory devices 123.

The memory devices 123 can implement a plurality of dynamic capacity devices (e.g., 152, . . . , 154). Each respective dynamic capacity device (e.g., 152, . . . , or 154) can be attached over the CXL fabric 121 to a host processor, such as a processing device 118, or another device 128 or 129. The respective dynamic capacity device (e.g., 152, . . . , or 154) can be implemented by a memory device 123 that implements a plurality of dynamic capacity devices, each attached over the fabric 121 to a different host processor. The respective dynamic capacity device (e.g., 152, . . . , or 154) can determine a maximum amount of memory resources currently available in the memory device 123 and can allocate up to the maximum amount as its capacity. The host processor (e.g., processing device 118 or another device 128 or 129) can determine, in view of the maximum amount, a desired capacity size of the respective dynamic capacity device (e.g., 152, . . . , or 154) that is no larger than the maximum amount. Using a communication protocol according to a standard of compute express link (CXL), the host processor can request the respective dynamic capacity device (e.g., 152, . . . , or 154) to configure itself to have the capacity size identified by the host processor. The respective dynamic capacity device (e.g., 152, . . . , or 154) can effectuate the capacity size change without restarting the memory device 123, the host processor, the host system 102, and/or the computing system 100.

In general, the memory devices 123 can service, via their connections to the fabric 121, multiple host processors, such as processing device 118 (e.g., central processing unit (CPU), system on a chip (SoC)), and other devices 128, . . . , 129 (e.g., artificial intelligence (AI) accelerator, graphical processing unit (GPU), network interface card). A subset of the dynamic capacity devices 152, . . . , 154 offered by the memory devices 123 can be attached to one host processor; and one or more other subsets can be attached to one or more other host processors.

Due to the differences in the memory devices 123 and/or the locations of the memory devices 123 in the network of CXL connections in the fabric 121, the dynamic capacity devices 152, . . . , 154 offered by the different memory devices 123 can have different performance levels 136, . . . , 138 in bandwidth, latency, and/or power consumption. Different combinations of capacity sizes of the dynamic capacity devices 152, . . . , 154 attached to a host processor (e.g., processing device 118, device 128 or 129) can lead to differently implemented performance levels 139 of the random access memory 112 for the host processor.

In one implementation, a memory manager 113 running in the host processor is configured to determine the desired capacity sizes of the dynamic capacity devices 152, . . . , 154 attached to the host processor such that the performance level 139 of the random access memory 112 attached via the fabric 121 to the host processor meets, or matches with, the current requirements of one or more applications running in the host processor. As the runtime status of the applications changes, the current requirements can change; and in response, the host processor can request the dynamic capacity devices 152, . . . , 154 to change their capacity sizes such that the performance level 139 of the random access memory 112 meets, or matches with, the current requirements.

In another implementation, the host processor communicates its memory requirements to a controller of the CXL fabric 121. The memory manager 113 running in the controller can request the dynamic capacity devices 152, . . . , 154 to change their capacity sizes on behalf of the host processor such that the performance level 139 of the random access memory 112 attached to the host processor satisfies, or approximately matches with, the current requirements.

In general, the performance level 139 of the random access memory 112 attached over the fabric 121 to the host processor can change in response to the communications workload applied to the fabric 121 and/or the memory access workload applied to the memory devices 123. The memory manager 113 (e.g., running in the host processor or in the controller of the fabric 121) can monitor the runtime performance level 139 of the random access memory 112 and request the dynamic capacity devices 152, . . . , 154 to change their capacity sizes such that the runtime performance level 139 of the random access memory 112 satisfies, or approximately matches with, the current requirements of the host processor.

Optionally, the memory devices 123 may not offer dynamic capacity devices for attaching to a host processor. Instead, the controller of the compute express link fabric 121 can offer a dynamic capacity device attachable to each host processor. The controller can dynamically allocate memory resources from the memory devices 123 to implement the dynamic capacity device such that the performance level 139 of the random access memory 112 provided via the dynamic capacity device offered by the controller satisfies, or approximately matches with, the current requirements of the host processor.

Optionally, the memory devices 123 offer dynamic capacity devices 152, . . . , 154 that are attached to the controller of the compute express link fabric 121. The controller in turn offers a dynamic capacity device attachable to a host processor. The controller uses a subset of the dynamic capacity device 152, . . . , 154 offered by the memory devices 123 to implement the dynamic capacity device offered by the controller over the fabric 121 to the host processor. The controller can dynamically adjust the capacity sizes of the dynamic capacity devices (e.g., 152, 154) in the subset such that the performance level 139 of the random access memory 112 provided via the dynamic capacity device offered by the controller satisfies, or approximately matches with, the current requirements of the host processor.

In FIG. 2, a main memory 124 is connected to a host processor (e.g., the processing device(s) 118) via a memory bus 109 (e.g., a double data rate (DDR) bus); and a memory sub-system 101 (e.g., as in FIG. 1) is connected to the processing device(s) using a peripheral bus 107 (e.g., a peripheral component interconnect express (PCIe) bus) that is different and separate from the memory bus 109. The main memory 124 is the primary tier memory of the host processor; and the random access memory 112 provided over the CXL fabric 121 and implemented using the dynamic capacity devices 152, . . . , 154 is the secondary tier memory of the host processor.

Optionally, a memory controller 116 (e.g., configured in the host processor) can manage the placement and movement of memory pages between the primary tier memory and the secondary tier memory. For example, applications running in the host processor (e.g., processing device 118) can use virtual memory addresses to access a page of memory. The page can be physically in the primary tier memory or in the secondary tier memory. When a page currently in the primary tier memory has not been used for more than a threshold length of time period, the memory controller 116 can move the page to the secondary tier memory and thus free up memory resources previously used by the page in the primary tier memory. The freed memory resources can then be used for a more frequently and/or recently accessed memory page.

When memory pages accessed by the applications are all in the primary tier memory, the memory controller 116 can decide that it is not necessary to have a large secondary tier memory; and a memory manager 113 in the memory controller 116 can request the dynamic capacity devices (e.g., 152, 154) that are attached to the host processor (e.g., processing device 118) and/or the memory controller 116 to reduce their capacity sizes. Reducing the capacity sizes of the dynamic capacity devices (e.g., 152, 154) in the memory devices 123 frees up resources in the memory devices 123 such that other dynamic capacity devices can increase their capacity sizes to service other host processors (e.g., devices 128, 129).

When memory pages accessed by the applications exceed the capacity of the primary tier memory, the memory controller 116 can decide to swap some pages from the primary tier memory to the secondary tier memory. When the current capacity size of the random access memory 112 in the secondary tier memory is insufficient, the memory controller 116 can request one or more of the dynamic capacity devices (e.g., 152, 154) that are attached to the host processor (e.g., processing device 118) and/or the memory controller 116 to increase their capacity sizes, in view of the current availability of memory resources in the memory devices 123.

When the activities of swapping pages between the primary tier memory and the secondary tier memory increase, the memory controller 116 can determine that the bandwidth and/or latency of the secondary tier memory limits the performance of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to increase the performance level 139 of the random access memory 112 in the secondary tier memory.

When the activities of swapping pages between the primary tier memory and the secondary tier memory decrease, the memory controller 116 can decide that the current performance level in bandwidth and/or latency of the secondary tier memory can be excessive in view of the reduced performance demand of the applications running in the host processor. Thus, the memory controller 116 can request one or more of the dynamic capacity devices (e.g., 152, 154) that are attached to the host processor (e.g., processing device 118) and/or the memory controller 116 to change their capacity sizes in a way to decrease the performance level 139 of the random access memory 112 in the secondary tier memory, which can free up resources in the memory devices 123 for use by other host processors (e.g., devices 128, 129).

Thus, the capacity, bandwidth, latency, and/or power consumption levels of the random access memory 112 in the secondary tier memory, attached over the fabric 121 to the host processor (e.g., processing device 118) and implemented using random access memory cells in the memory devices 123, can change in view of the real time memory activities and demands of the applications running in the host processor.

Alternatively, the memory controller 116 can be configured to send the memory configuration requirements (e.g., capacity, bandwidth, latency, and/or power consumption) to the controller of the fabric 121 to cause the controller to adjust the implementation of the secondary tier memory without restarting the host processor, the host system 102, and/or the computing system 100.

Optionally, the memory controller 116 can be configured to use at least a portion of the main memory 124 as a cache memory for accessing the random access memory 112 in the secondary tier memory.

In some implementations, a portion of the memory of the host system 102 as a whole, including the main memory 124 in the primary tier memory of the processing devices 118 and the random access memory 112 in the secondary tier memory, can be allocated to support the operations of the memory sub-system 101.

For example, a portion of the memory can be allocated as a host memory buffer (HMB) of the memory sub-system 101. The host memory buffer can be used to buffer a portion of a logical to physical translation table of the memory sub-system 101.

The memory sub-system 101 can use its non-volatile memory cells 114 (e.g., NAND memory) for persistent storage of metadata 131, such as the logical to physical translation table. The storage capacity of the memory cells 114 is used to store both user data 133 and the metadata 131 about the storage of the user data 133.

Accessing the non-volatile memory cells 114 for address translation computations can be slower than accessing the host memory buffer. To improve the speed of address translation operations, the memory manager 113 in the memory sub-system 101 can load an actively used portion of the logical to physical translation table into its local memory 119, and load another portion of the logical to physical translation table that is likely to be used into the host memory buffer. Such an arrangement can reduce the need to read and write the non-volatile memory cells 114 to use and update the logical physical translation table and thus improve the overall performance of the memory sub-system 101 in providing its storage services. Optionally, the memory sub-system 101 can use a portion of the logical to physical translation table in the host memory buffer directly in address translation without loading the portion into the local memory 119.

When the workload for the memory sub-system 101 changes, the memory demand (e.g., resources need for the host memory buffer) can change. The memory manager 113 can adjust the performance level 139 and/or the capacity size of the secondary tier memory based on the memory demand of the memory sub-system 101.

In some implementations, the memory sub-system 101 can access, over the CXL fabric 121, the host memory buffer in the memory devices 123 without going through and/or without assistance from the processing devices 118 connected to the main memory 124, as in FIG. 3

In FIG. 3, a set of bus connections 137 can interconnect the peripheral bus 107 (e.g., a peripheral component interconnect express (PCIe) bus), the memory bus 109 (e.g., a double data rate (DDR) bus) and the CXL fabric 121. The memory sub-system 101 is configured with a direct memory access (DMA) engine 135 operable to access the memory in the host system 102, including the main memory 124 and the random access memory (e.g., 112) implemented using the memory devices 123 connected via the fabric 121.

Using the DMA engine 135 the memory manager 113 of the memory sub-system 101 can copy a portion of the logical physical translation table from the local memory 119 to the host memory buffer in the memory devices 123. Thus, the local memory 119 can be freed for storing another portion of the logical to physical translation table for active use, or for other memory usages.

For example, the memory sub-system 101 can retrieve a portion of the logical to physical translation table from the non-volatile memory cells 114 into the local memory 119 and then copy the portion to the host memory buffer (e.g., for buffering/caching, and/or for reference in address translation).

For example, the memory sub-system 101 can store a portion of the logical to physical translation table in the local memory 119 for active address translation operations. When subsequent operations do not use the portion for a period of time, the memory sub-system 101 can offload the portion to the host memory buffer for buffering and to load another portion of the logical to physical translation table (e.g., from the host memory buffer, or the memory cells 114) for active use.

When a portion of the logical physical translation table in the host memory buffer is to be used actively, the DMA engine 135 can fetch the portion of the logical physical translation table from the host memory buffer into the local memory 119 without assistance from the processing device(s) 118.

In some implementations, the DMA engine 135 and/or the memory sub-system 101 can function as a host of the main memory 124 and/or the random access memory (e.g., 112) implemented using the memory devices 123 connected via the fabric 121. Thus, the memory sub-system 101 can configure a portion of the local memory 119 as a cache memory for accessing the random access memory (e.g., 112) implemented using the memory devices 123 connected to the fabric 121, including the host memory buffer.

In some implementations, the connection 107 to the memory sub-system 101 is also a compute express link (CXL) connection to the fabric 121, as in FIG. 4.

When the memory sub-system 101 is connected to the fabric 121 via a compute express link (CXL) connection, the memory sub-system 101 and/or a direct memory access (DMA) engine in the memory sub-system 101 can use the random access memory (e.g., 112) implemented using the memory devices 123 connected via the fabric 121 in a way similar to the processing device(s) 118 using the random access memory (e.g., 112). The memory sub-system 101 can dynamically allocate a portion of the random access memory (e.g., 112) as its host memory buffer to store the entire logical to physical translation table or a portion of it, without assistance from the processing device(s) 118 connected to the main memory 124.

In some implementations, when the memory sub-system 101 is connected to the fabric 121 via a compute express link (CXL) connection, a controller of the CXL fabric 121 can use the storage space of the non-volatile memory cells 114 to provide a logical memory device (e.g., a dynamic capacity device) having a memory space of random access memory accessible by various hosts connected to the fabric 121, such as the processing device(s) 118 and other devices 128, . . . , 129 (e.g., artificial intelligence (AI) accelerator, graphical processing unit (GPU)), as further discussed below. Thus, the devices (e.g., 118, 128, 129) connected to the fabric 121 can virtually access the memory sub-system 101 over the fabric 121 as if the storage space of the memory sub-system 101 (e.g., the capacity of the non-volatile memory cells 114) were random access memory.

Different portions of the capacity of a storage device (e.g., solid-state drive) are typically configured to be addressed for access using logical block addressing (LBA) addresses. Each LBA address represents a predetermined amount of capacity (e.g., 512 bytes, 4 KB), which is significantly larger than the capacity represented by a memory address for accessing a random access memory.

Different portions of a random access memory (e.g., 112, main memory 124) are typically configured to be addressed for access using memory addresses. Each memory address represents a predetermined amount of capacity (e.g., one byte, eight bytes, or 128 bytes), which is significantly smaller than the capacity of an LBA address for accessing a storage device.

Communication protocols for accessing via LBA addresses and for accessing via memory addresses are typically adapted differently to accommodate typical patterns of accessing: large chunks of data accessed via LBA addresses and small chunks of data accessed via memory addresses.

For example, when a large chunk of data is accessed via an LBA address, it is possible to use a relatively large amount of communication overhead to implement enhanced features without significantly degrading the system performance. In contrast, when a small chunk of data is accessed via a memory address, an increase in communication overhead can significantly degrade the system performance. Thus, block-based storage devices and random access memory devices are typically not interchangeable in their usages in a computing system.

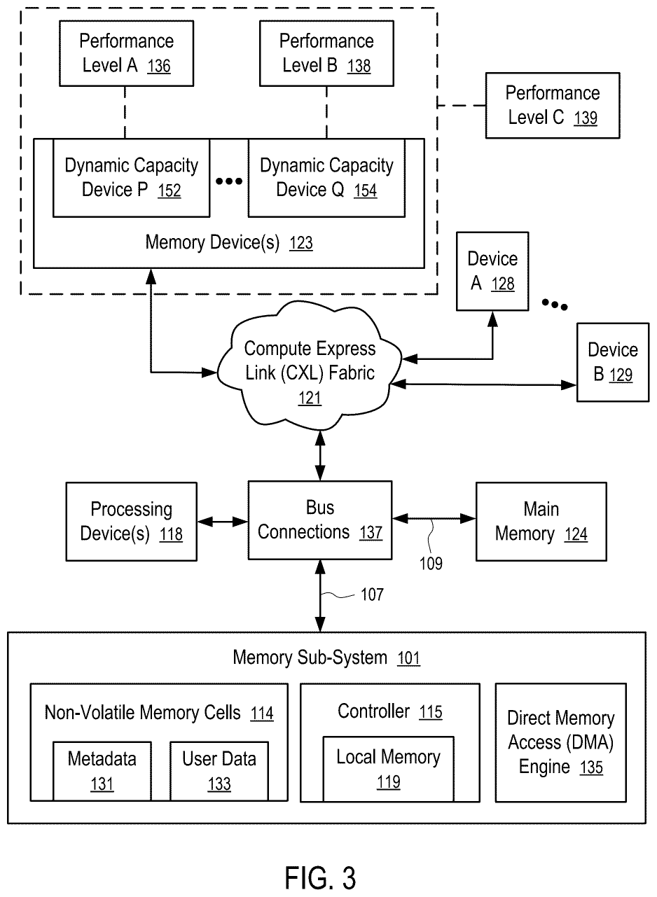

FIG. 5 shows a compute express link fabric configured to provide a secondary tier memory according to one embodiment. For example, the compute express link fabric 121 discussed above in connection with FIG. 1 to FIG. 4 can be implemented as in FIG. 5.

In FIG. 5, the compute express link fabric 121 includes a plurality compute express link switches (e.g., 221, 223, 225). Each of the switches (e.g., 221, 223, or 225) has a plurality of ports connected to separate compute express link connections. A switch (e.g., 221, 223, or 225) is configured to route a memory access request or response received at one port to another. A compute express link connection in the fabric 121 can connect a port of one switch to a port of another switch, or to a memory device (e.g., 141, 143, or 145), or to a memory sub-system (e.g., 161, or 163), or to a host processor, such as a processing device 118 (e.g., a CPU, a CPU core, an SoC) or another device (e.g., 128 or 129, such as a GPU, a GPU core, an AI accelerator).

A controller 122 of the fabric 121 can control the switches (e.g., 221, 223, or 225) of the fabric 121 to implement a look up table or address mapping 165 for routing memory access requests having addresses specified by a host processor (e.g., processing device 118, or device 128 or 129) into addresses of random access memory cells in the memory devices 141, 143, . . . , 145.

The controller 122 can include a fabric manager and/or a memory manager 113 to adjust the mapping 165 for implementing a random access memory 112 in a secondary memory tier using memory resources in the memory devices 141, 143, . . . , 145, with or without the use of techniques of dynamic capacity devices (e.g., 152, 154) offered by the memory devices 141, 143, . . . , 145. Optionally, the memory resources are provided by the memory devices 141, 143, . . . , 145 in the form of dynamic capacity devices (e.g., 152, . . . , 154) attached to the controller 122 over the fabric 121. Alternatively, the memory resources can be provided by the memory devices 141, 143, . . . , 145 via random access memory cells addressable by the controller 122 without the use of the dynamic capacity devices offered by the memory devices 141, 143, . . . , 145; and thus, the techniques can be used even when the memory devices 141, 143, . . . , 145 do not implement the functions and protocols of dynamic capacity devices.

In some implementations, the memory manager 113 (and/or the fabric manager) is configured on a centralized device in communication with the switches 221, 223, . . . , 225 in the fabric 121. In other implementations, the memory manager 113 (and/or the fabric manager) is implemented via a set of agents each running in one of the switches 221, 223, . . . , 225. The agents can be configured to make separate and independent routing decisions. The agents can collectively implement the operations of the controller 122 by each routing memory access traffic from one port of a switch to another port of the same switch in which the agent is running.

The controller 122 of the compute express link fabric 121 (e.g., as discussed above in connection with FIG. 1 to FIG. 4) can monitor the changing memory/storage usage patterns and/or the real time performance level 139 of a random access memory 112 in the secondary tier memory of a host processor (e.g., device 118, 128, or 129). When the real time performance level 139 deviates from a requirement from the host processor, the controller 122 can change the mapping 165 at the run time such that the performance level 139 of the random access memory 112 in the secondary tier memory meets, or matches with, the performance requirement specified by the host processor (e.g., processing device 118, or device 128 or 129).

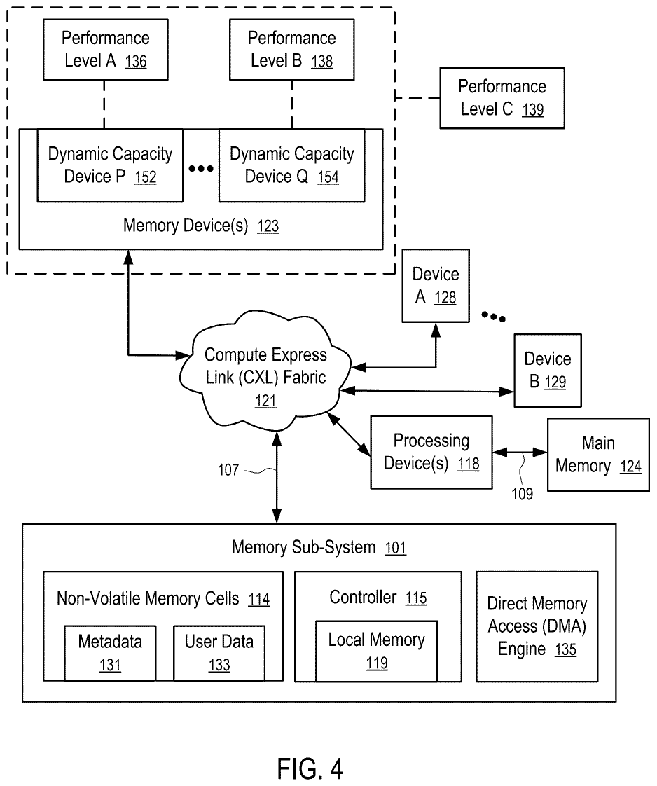

FIG. 6 shows the attaching of dynamic capacity devices over a compute express link fabric to provide a random access memory according to one embodiment. For example, the random access memory 112 in the secondary tier memory of a host processor 106 (e.g., processing device 118, or device 128 or 129) in a computing system 100 of FIG. 1 can be implemented via attaching dynamic capacity devices as in FIG. 6 over a compute express link fabric 121 configured as in FIG. 2 to FIG. 5.

In FIG. 6, the host processor 106 has a main memory 124 that is connected to the host processor 106 via a memory bus 109 to provide a primary tier memory of the host processor 106.

Further, the host processor 106 can have a random access memory 112 in a secondary tier memory that is implemented via a plurality of memory devices (e.g., 141, . . . , 143) connected over a compute express link fabric 121.

Each of the memory devices (e.g., 141, 143) can offer a plurality of dynamic capacity devices (e.g., 151, 153, . . . ; 155, . . . ). At least one of the dynamic capacity devices (e.g., 151, 153, . . . ) of a memory device 141 can be attached over the compute express link fabric 121 to the host processor 106. For example, during a boot up process, the operation of attaching 209 some dynamic capacity devices (e.g., 151, . . . , 155) to the host processor 106 is performed. For example, a dynamic capacity device (e.g., 151, or 155) attached to the host processor 106 can be configured for exclusive use by the host processor 106; and other host processors are prevented from accessing, over the CXL fabric 121, the dynamic capacity device (e.g., 151, or 155) attached to the host processor 106.

For example, a dynamic capacity device 151 of the memory device 141 is attached to the host processor 106 to implement a portion of the random access memory 112, where the size of the portion is adjustable via adjusting the capacity size of the dynamic capacity device 151; and a dynamic capacity device 155 of the memory device 143 is attached to the host processor 106 to implement another portion of the random access memory 112, where the size of the portion is adjustable via adjusting the capacity size of the dynamic capacity device 155.

Each of the dynamic capacity devices (e.g., 151, 155) can have a capacity size that is dynamically requested by the host processor 106. A memory device (e.g., 141) is configured to dynamically allocate memory resources within the memory device (e.g., 141) to satisfy the capacity size request from the host processor 106. The capacity size of the random access memory 112 is the sum of the capacity sizes of the dynamic capacity devices 151, . . . , 155 attached to the host processor 106. To access a location in the random access memory 112, the host processor 106 identifies a dynamic capacity device (e.g., 151) and a memory address within the current capacity size of the dynamic capacity device (e.g., 151).

For example, the host processor 106 can cause the random access memory 112 to be implemented using memory resources from the memory device 141 but not memory resources from other memory devices (e.g., 143) by requesting the dynamic capacity device 151 to have a capacity size that is equal to the capacity size of the random access memory 112, and requesting the other dynamic capacity devices (e.g., 155) attached to the host processor 106 to have capacity sizes equal to zero. As a result, the characteristics (e.g., bandwidth, latency, power consumption) of the random access memory 112 are determined by the memory device 141 and its position in the fabric 121 relative to the host processor 106.

For example, the host processor 106 can cause the random access memory 112 to be implemented using memory resources from the memory devices 141 and 143 but not memory resources from other memory devices by requesting the dynamic capacity devices 151 and 155 to have capacity sizes that are larger than zero, and requesting the other dynamic capacity devices attached to the host processor 106 to have capacity sizes equal to zero. As a result, the capacity size of the random access memory 112 is equal to the sum of the capacity sizes of the dynamic capacity devices 151 and 155; and the characteristics (e.g., bandwidth, latency, power consumption) of the random access memory 112 are determined by the memory devices 141 and 143, the ratio of their capacity sizes, and their positions in the fabric 121 relative to the host processor 106.

The host processor 106 can request changes in the capacity sizes of the dynamic capacity devices 151, . . . , 155 attached to the host processor 106 without a need to restart the host processor 106, the memory devices 141, . . . , 143, and/or the computing system 100 containing the host processor 106 and the memory devices 141, . . . , 143.

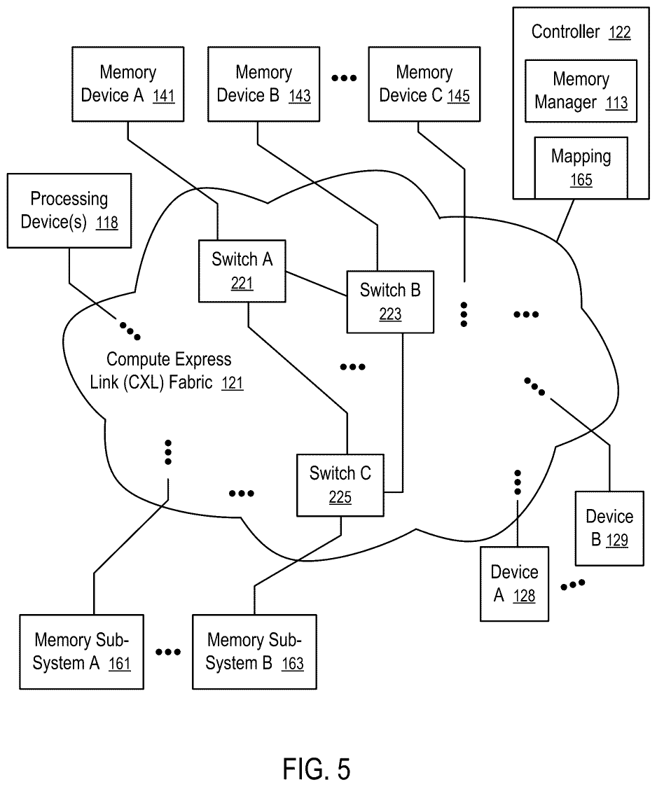

FIG. 7 shows a mapped memory space implemented via a compute express link fabric to provide a dynamically adjustable random access memory according to one embodiment. For example, the random access memory 112 of FIG. 1 provided over a compute express link fabric 121 can be implemented using a mapped memory space 171 and a controller 122 of the fabric 121.

In FIG. 7, the mapped memory space 171 is implemented via the controller 122 of the compute express link (CXL) fabric 121 connecting a plurality of memory devices 141, 143, . . . , 145 having random access memory cells (e.g., as in FIG. 2 to FIG. 6).

A host processor (e.g., 106) can be a processing device 118, or another device (e.g., 128, or 129 in FIG. 2 to FIG. 5). The host processor 106 can send a memory access request using a memory address in the mapped memory space 171 to access the random access memory 112 connected to the host processor 106 via the fabric 121.

A memory region 174 of the mapped memory space 171 can correspond to the random access memory 112 in a secondary tier memory of the host processor 106.

For example, the controller 122 can offer a dynamic capacity device 152 that has a set of memory addresses in the memory region 174. During a boot up process, the dynamic capacity device 152 is attached to the host processor 106. When the host processor 106 accesses the memory addresses in the dynamic capacity device 152, the controller 122 maps the memory access requests to one or more portions in the memory devices 141, 143, . . . , 145 connected to the fabric 121. Thus, the memory devices 141, 143, . . . , 145 do not have to implement the functions and protocols of dynamic capacity devices; and the dynamic capacity device 152 can be implemented, via the controller 122 mapping 165 memory addresses in the memory region 174 to the memory devices 141, 143, . . . , 145, using the memory resources allocated from one or more of the memory devices 141, 143, . . . , 145.

Since the memory region 174 is formulated based on the identity of the dynamic capacity device 152, the size of the memory region 174 can change dynamically without impacting the usages of memory regions allocated for other uses.

For example, the mapped memory space 171 can have memories 173, . . . , 175 allocated respectively for the memory sub-systems 161, . . . , 163, such as submission queues 181, 185 for the memory sub-systems 161, 163 to obtain commands for execution, and completion queues 183, 187 for the memory sub-systems 161, 163 to provide completion records after execution of the commands. For example, the queues (e.g., 181, 183, 185, 187) can be used to facilitate communications with the memory sub-systems 161, . . . , 163 for storage access (e.g., according to a non-volatile memory express (NVMe) standard).

For example, a memory sub-system (e.g., 161) is allowed to retrieve commands from its submission queues (e.g., 181) but not allowed to retrieve commands from submission queues (e.g., 185) configured for other memory sub-systems (e.g., 163). Similarly, a memory sub-system (e.g., 161) is allowed to enter completion messages into its submission queues (e.g., 183) but not allowed to enter messages into completion queues (e.g., 185) configured for other memory sub-systems (e.g., 163).

The host processor 106 can send commands (e.g., read commands, write commands) to a memory sub-system (e.g., 161, or 163) by entering the commands in a submission queue (e.g., 181 or 185) configured for the memory sub-system (e.g., 161, or 163). For example, the processing device(s) 118 of the host system 102 can write a command into the submission queue 181 (e.g., in accordance with a NVMe standard); and the memory sub-system 161 can subsequently retrieve the command from the submission queue 181 (e.g., in accordance with the NVMe standard) for execution.

Optionally, the memory 173 (or 175) can be encapsulated in another dynamic capacity device offered by the controller 122 such that the capacity of the memory 173 can increase or decrease dynamically without a need for restarting.

Optionally, the mapped memory space 171, implemented according to mapping 165 in the controller 122, can have different portions allocated as host memory buffers for the memory sub-systems 161, . . . , 163.

In some implementations, a submission queue (e.g., 181) in the mapped memory space 171 is reserved for the controller 122 of the compute express link fabric 121 to send commands to operate the respective memory sub-system (e.g., 161).

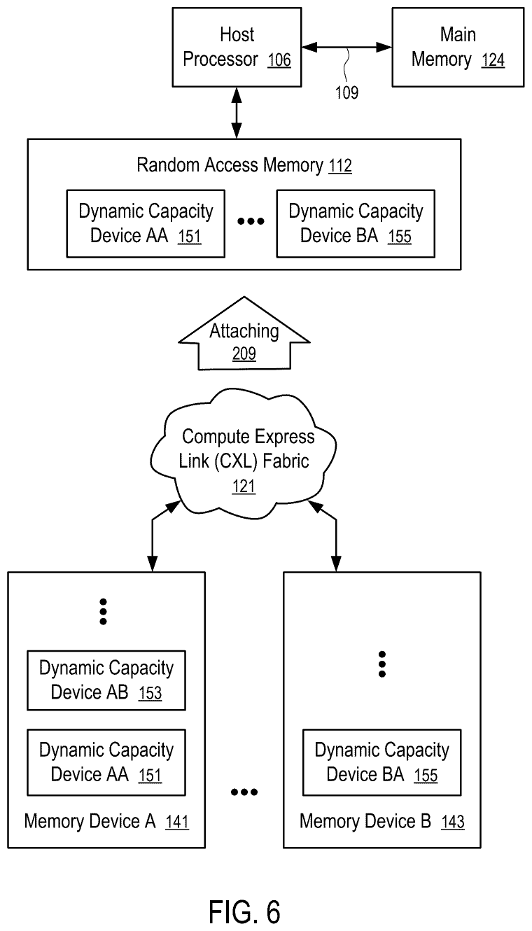

For example, the controller 122 can use a portion of the memory space 171 to cache a portion of the memory sub-system 161 (e.g., as illustrated in FIG. 8) via sending commands to the memory sub-system (e.g., 161) via the submission queue (e.g., 181) without assistance from the host processor 106. Thus, the host processor 106 can access the cached portion of the memory sub-system 161 without the need to send storage access commands to the memory sub-system (e.g., 161) using a submission queue. The controller 122 can generate the storage access commands for the host processor 106 in response to the memory access requests received in the fabric 121 from the host processor 106. Such a cached portion can be included in the memory region 174; and using such a technique, the controller 122 can also use a portion of the memory sub-system 161 to implement the persistent storage of data (e.g., 177) in at least a portion of the dynamic capacity device 152.

Thus, the dynamic capacity device 152 attached as at least a portion of the random access memory 112 in the secondary memory tier of the host processor 106 can be implemented using not only the memory resources in the memory devices 141, 143, . . . , 145 that have random access memory cells accessible via memory access protocols, but also the storage resources of the memory sub-systems 161, . . . , 163 that are configured to be accessed via storage access protocols.

For example, when a portion of the random access memory 112 used by an application running in the host processor 106 becomes cold (e.g., have not been used for a time period longer than a threshold and/or is predicted to be not used for a time period longer than a threshold), the controller can store the data (e.g., 177) of such a portion into a memory sub-system (e.g., 161 or 163) and update the mapping 165 to indicate that the data 177 of the portion of the memory region 174 is currently residing in the memory sub-system (e.g., 161 or 163). As a result, the corresponding portion of random access memory cells in the memory devices 141, 143, . . . , 145 can be freed and/or reallocated for use in a more memory-demanding application and/or by a more memory-demanding host processor.

Optionally, the host processor 106 can enter a read command in the submission queue 185 configured for the memory sub-system 163. After the memory sub-system 163 retrieves the read command from the submission queue 185, the memory sub-system 163 can execute the read command to retrieve data (e.g., 177) from its storage medium (e.g., non-volatile memory cells 114) and write the data (e.g., 177) to a memory address identified in the read command. For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 163 can send the data (e.g., 177) to the memory address identified in the read command without assistance from the host processor 106.

Optionally, the host processor 106 can enter a write command in the submission queue 181 configured for the memory sub-system 161. After the memory sub-system 161 retrieves the write command from the submission queue 181, the memory sub-system 161 can execute the write command by retrieving data (e.g., 177) from a memory address identified in the write command and programming its storage medium (e.g., non-volatile memory cells 114) to store the data (e.g., 177). For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 161 can load the data (e.g., 177) from the memory address identified in the write command without assistance from the host processor 106.

Optionally, the controller 122 can offer to attach a plurality of dynamic capacity devices 152, . . . , 154 to the host processor 106 during the boot time of the computing system 100. Each of the dynamic capacity devices 152, . . . , 154 can offer a variable capacity size and a dynamically adjustable performance level for a segment of the random access memory 112 implemented using the dynamic capacity devices 152, . . . , 154. The controller 122 can use the mapping 165 to route, via the compute express link fabric 121, memory access requests addressing the dynamic capacity devices 152, . . . , 154 to physical addresses of random access memory cells in the memory devices 141, 143, . . . , 145. Thus, different segments of the random access memory 112 can have different nominal performance levels. Optionally, the dynamic capacity devices 152, . . . , 154 can be implemented respectively using separate dynamic capacity devices (e.g., 151, . . . , 155) offered by the memory devices (e.g., 141, . . . , 143).

Alternatively, the random access memory 112 of the host processor 106 is implemented using a single dynamic capacity device 152 offered by the controller 122 and implemented using the memory resources of the memory devices 141, 143, . . . , 145 and/or the memory sub-systems 161, . . . , 163.

FIG. 8 illustrates a controller of a compute express link (CXL) fabric caching portions of memory sub-systems in the memory space provided by memory devices connected to the fabric according to one embodiment.

In FIG. 8, the memory sub-systems 161, . . . , 163 can be attached to a host system 102 having a compute express link (CXL) fabric 121 as in FIG. 2 to FIG. 7. Each of the memory sub-systems 161, . . . , 163 can be implemented in a way as in FIG. 1. The controller 122 of the fabric 121 can implement the mapped memory space 171 using the random access memory cells in the memory devices 141, 143, . . . , 145 connected to the CXL fabric 121.

For example, a memory sub-system 161 can have a storage space 231 addressable via logical block addressing (LBA) addresses using storage access commands. A portion of the storage space 231 can be cached in the mapped memory space 171 as a cached portion 232 that is physically mapped to one or more portions in the memory devices (e.g., 141, 143, and/or 145) connected to the fabric 121, in a way similar to the memory region 174 corresponding to a dynamic capacity device 152 being mapped and implemented using portions of the memory devices 141, 143, . . . , 145 connected to the fabric 121.

Similarly, a storage space 233 in the memory sub-system 163 can have a portion cached as a cached portion 234 in the mapped memory space 171. The cached portion 234 can be implemented using portions of the memory devices 141, 143, . . . , 145, in a way similar to the implementation of dynamic capacity device 152.

A host processor 106 (e.g., processing device 118 or another device 128 or 129) can optionally access the memory sub-systems 161, . . . , 163 via entering storage access commands into the submission queues (e.g., 181, 185) configured for the memory sub-systems 161, . . . , 163, or send memory access commands to the fabric 121 using memory addresses of the cached portions (e.g., 232, 234).

In some implementations, a cached portion (e.g., 232, or 234) is part of the memory region 174 (e.g., in FIG. 7) corresponding to the dynamic capacity device 152 to implement the random access memory 112 in the secondary tier memory of the host processor 106.

Optionally, the controller 122 can be configured to present the entire storage space 231 of the memory sub-system 161 as a cached portion 232 in the mapped memory space 171 such that a host processor 106 (e.g., the processing device 118, or device 128 or 129) can use the storage space 231 without using storage access commands and without using submission queues (e.g., 181) configured for the memory sub-system 161. Thus, the submission queues (e.g., 181) configured for the memory sub-system 161 can be reserved for exclusive use by the controller 122 in implementing the cached portion 232. The host processor 106 can access the cached portion 232 using memory access requests instead of storage access commands.

For example, the controller 122 can be configured to present (e.g., to the processing device(s) 118 and other devices 128, . . . . 129 connected to the fabric 121) the entire storage space 231 of the memory sub-system 161 as a portion of a random access memory in the mapped memory space 171, as if the memory sub-system 161 were a random access memory device. For example, the storage space 231 can have a capacity larger than the combined random access memory capacity of the memory devices 141, 143, . . . , 145; and thus, the mapped memory space 171 can be larger than the combined random access memory capacity of the memory devices 141, 143, . . . , 145. The controller 122 can configure its mapping 165 to map an actively used portion of the storage space 231 as a cached portion 232 that is currently mapped into portions of the memory devices 141, 143, . . . , 145, while other portions of the storage space 231 as mapped to the memory space 171 are not concurrently implemented using the random access memory in the memory devices 141, 143, . . . , 145. The memory space 171 implemented using the storage space 231 can be actually implemented using the memory devices 141, 143, . . . , 145 one portion at time. Thus, the portion of the memory space 171 implemented using the storage space 231 can have persistent storage in the memory sub-system 161, while an actively used portion of the storage space 231 is implemented (e.g., mirror or cached) in the memory devices 141, 143, . . . , 145.

For example, when the host processor 106 requests accesses to memory addresses in the mapped memory space 171 that correspond to a portion of the storage space 231, the controller 122 can determine a corresponding LBA address of the portion. If the storage space represented by the LBA address is not already cached or mirrored in the memory space 171 using random access memory of the memory devices 141, 143, . . . , 145, the controller 122 can dynamically allocate one or more portions from the memory devices 141, 143, . . . , 145, enter a read command in the submission queue 181 configured for the memory sub-system 161 to retrieve the data at the LBA address into the cached portion 232 implemented using the dynamically allocated portions of the memory devices 141, 143, . . . , 145, and route the memory access requests from the processing device(s) 118 over the fabric 121 to the memory devices 141, 143, . . . , 145.

When the controller 122 determines that the cached portion 232 is not likely to be accessed by the processing device(s) 118 in a subsequent period of time and the content of the cached portion 232 has not yet been committed into the storage space 231, the controller 122 can enter a write command in the submission queue 181 to write the data of the cached portion 232 into the memory sub-system 161. Upon receiving a completion message in the completion queue 183 that indicates the completion of the write command, the controller 122 can free the random access memory allocated from the memory devices 141, 143, . . . , 145 to implement the cached portion 232, which can then be reused to implement another cached portion of the storage space 231 of the memory sub-system 161, or a cached portion 234 of the storage space 233 of another memory sub-system 163.

Thus, the controller 122 can effectively provide a mapped memory and storage service for devices (e.g., 118, 128, 129) connected to the compute express link (CXL) fabric 121 through the use of mapping 165 to route memory access requests to the memory devices 141, 143, . . . , 145 over the CXL fabric 121 and the use of the submission queues (e.g., 181, 185) and completion queues (e.g., 183, 187) to operate the memory sub-systems 161, . . . , 163. The devices (e.g., 118, 128, 129) can access the storage spaces 231, . . . , 233 of the memory sub-systems 161, . . . , 163 via the memory devices 141, 143, . . . , 145 that are dynamically mapped by the controller 122 as proxies. Since the tasks of using message queues (e.g., 181, 183, 185, 187) to communicate with memory sub-systems (e.g., 161, 163) are offloaded to the controller 122 of the CXL fabric 121, the complexity of routines and applications running in the processing devices (e.g., 118, 128, 129) can be reduced.

Optionally, the storage spaces 231, . . . , 233 of the memory sub-systems 161, . . . , 163 can be used to implement part of the dynamic capacity devices (e.g., 152, 154) attached by the controller 122 to host processors (e.g., 106).

Optionally, the controller 122 can dynamically adjust the mapping 165 of which portions of the mapped memory space 171 are mapped to which of the memory sub-systems 161, . . . , 163 connected to the CXL fabric 121. The controller 122 can adjust the mapping 165 to balance the workloads on the memory sub-systems 161, . . . , 163 and thus improve the performance of the system.

The mapped memory and storage services allow the host processors (e.g., devices 118, 128, 129) connected to the CXL fabric 121 to access the mapped memory space 171 using memory addresses and memory access requests at a granularity of random memory access (e.g., in a unit of one byte, eight bytes, or 128 bytes), while the data stored into at least a portion of the memory space 171 is stored persistently in the storage spaces (e.g., 231, 233) of the memory sub-systems 161, . . . , 163. The host devices (e.g., 118, 128, 129) can be relieved from operations of entering commands in submission queues (e.g., 181, 185) configured for the memory sub-system 161, . . . , 163. At least a portion of the random access memory of the memory devices 141, 143, . . . , 145 can be used dynamically by the controller 122 as the cache memory for access in the storage spaces 231, . . . , 233 of the memory sub-systems 161, . . . , 163, without the host processors (e.g., devices 118, 128, 129) performing operations to manage or effectuate the caching.

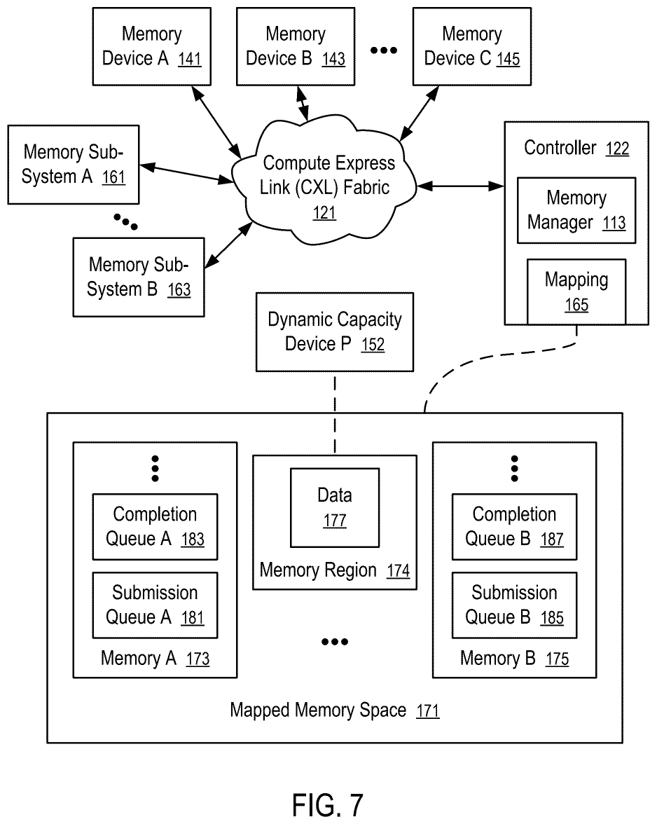

FIG. 9 shows a compute express link switch 220 configured to implement a dynamically adjustable random access memory 112 according to one embodiment. For example, the compute express link fabric switch 220 of FIG. 9 can be used to implement one or more, or each, of the switches (e.g., 221, 223 or 225) in the compute express link fabric 121 discussed above in connection with FIG. 1 to FIG. 7.

The compute express link fabric switch 220 can have a plurality of ports 235, 237, . . . , and 239. A port (e.g., 235) of the switch 220 can be connected to a memory device (e.g., 141). Such a port can be considered a device-connected port (e.g., 235). When a memory address in a memory access request is mapped to the memory device (e.g., 141) attached to the port (e.g., 235), the switch 220 routes the memory access request to the port (e.g., 235).

A port (e.g., 237) of the switch 220 can be connected to another switch (e.g., 225 or 188). Such a port (e.g., 237) can be considered a switch-connected port (e.g., 237). When a memory address in a memory access request is not mapped to the memory device (e.g., 141) attached to the port (e.g., 237), the switch 220 can route the memory access request to a switch-connected port (e.g., 237). A set of switches (e.g., 188) connected to the switch-connected port(s) (e.g., 237) of the switch 220 can be considered a fabric 126. In general, the switch 220 can have the options to route such a memory access request to more than one switch-connected port (e.g., 239) of the switch 220.

Optionally, the switch 220 can have a memory manager 113 configured to map memory access requests to its ports 235, 237, . . . , 239 according to its data of address mapping 165. Alternatively, a controller 122 configured separately from the switch 220 can provide data to instruct the switch 220 in routing the memory access requests coming into ports of the switch 220.

For example, the mapping 165 in the switch 220 and/or in the controller 122 can be configured to indicate that a portion of the memory region 174 represented by a dynamic capacity device 152 is mapped to a portion 251 in the memory device 141. For example, another portion of the memory region 174 represented by the dynamic capacity device 152 is mapped to a portion 257 in the memory sub-system 163. For example, a portion of the memory region represented by another dynamic capacity device (e.g., 154) can be mapped to a portion 253 in the memory device 141.

Since the mapping 165 can be adjusted and/or updated in the switch 220 and/or in the controller 122 without a need to restart the computing system 100 or a portion of it, the host processor 106 can request the adjustment of the capacity size of the dynamic capacity device 152, attached to implement at least a portion of its random access memory 112, without the need for restarting. When the request is received in the fabric 121, the controller 122 and/or the switch 220 can adjust the mapping 165 to implement the capacity change for the dynamic capacity device 152. Alternatively, a dynamic capacity device (e.g., 151) attached to the host processor 106 is offered by a memory device (e.g., 141); and a request to adjust its capacity size received in the fabric is routed through the fabric 121 to the memory device (e.g., 141) for execution.

At least some embodiments disclosed herein include techniques to control allocations of memory from a heterogeneous memory system to a plurality of threads of an application running in a computing system (e.g., 100 in FIG. 1).

For example, the computing system 100 of FIG. 1 has a heterogeneous memory system, including a main memory 124 connected to a processing device 118 via a memory bus 109 (e.g., a double data rate (DDR) bus) and a secondary random access memory 112 connected to the processing device 118 via a compute express link (CXL) fabric 121. The processing device 118 can have a plurality of cores operable to run a plurality of threads in parallel.

For example, an application of inferencing using a large language model (LLM) typically uses multiple threads of parallel execution to accelerate computations using multiple sets of computing hardware (e.g., GPUs, GPU cores, AI accelerators). A compute express link (CXL) fabric (e.g., 121) can be used to provide a heterogeneous memory to balance various design options, such as performance, capacity, latency, bandwidth, power consumption, etc.

Different ways to allocate memory from the heterogeneous memory system to the threads of the application can have an impact on the overall performance and cost of running the application in the computing system 100. However, it is challenging to design an optimized policy to allocate memory resources to the concurrent threads of the application.

Instead of a static memory allocation policy, a machine learning technique can be configured to learn (e.g., via reinforcement learning (RL)) best policies to allocate memory to the threads based on real world usages of the application.

For example, a reinforcement learning agent can be configured (e.g., as a portion of the memory manager 113) to select and/or adjust, based on an adjustable reward model, memory allocation policies in view of a current state of input patterns and workloads of threads (e.g., portions of LLM handled by different threads). As the result of a selection or adjustment identified by the reinforcement learning agent, a reward is provided to the reinforcement learning agent based on the performance of the application resulting from implementing the policy selection/adjustment. The reward can be used by the reinforcement learning agent to adjust its reward model in predictions of expected rewards for selecting different policy selections/adjustments at different states of the application. Actual rewards provided to the reinforcement learning agent for selecting/adjusting memory allocation policies at various states of the application can train the reward model to improve its predictions.

As the reward model converges, the reinforcement learning agent is to select policy/adjustments to maximize expected rewards based on predictions of the reward model. Rewards provided to the reinforcement learning agent are based on the performance levels of the application. Thus, maximizing rewards correspond to selecting memory allocation policies that improve and/or maximize the performance of the application.

When the workload of the application changes, the reinforcement learning agent can continue updating its reward model according to actual rewards received. Thus, the reward model of the reinforcement learning agent can adapt to the changing workload of the application to improve or maximize the performance of the application via tuning selections/adjustments to the policy of allocation memory from the heterogeneous memory system to the threads of the application.

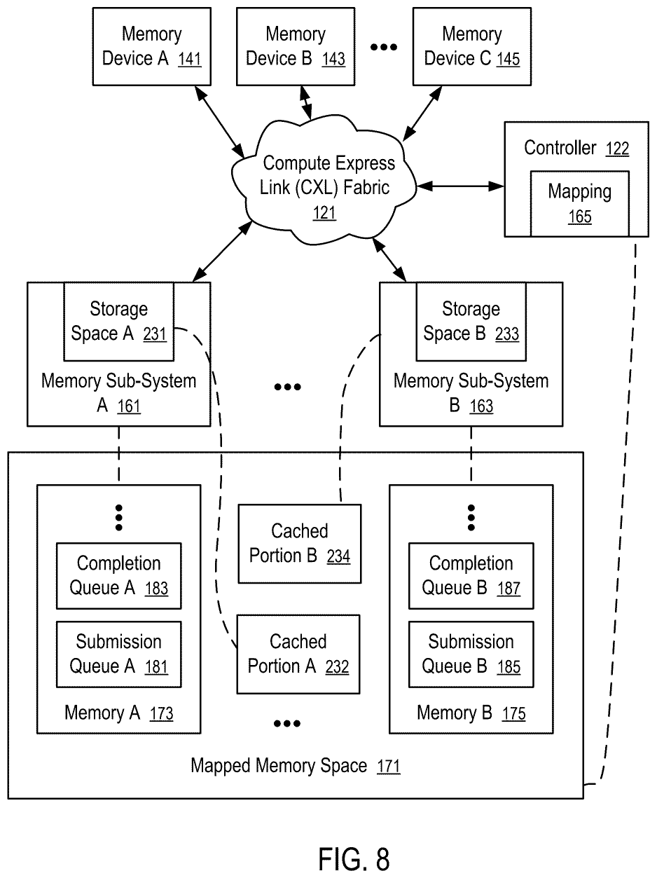

FIG. 10 illustrates a reinforcement learning technique to manage allocation of memory to threads of an application according to one embodiment. For example, the technique of FIG. 10 can be used in a computing system 100 running an application 201 having multiple threads (e.g., 261, 262, . . . , 263) being executed in parallel.

The threads 261, 262, . . . , 263 can request the allocation of memories 265, 266, . . . , 267 respectively for their computing tasks in the host system 102. The performance of the memories 265, 266, . . . , 267 can affect the execution progress in the threads (e.g., 261, 262, . . . , 263) and thus affect cooperation among some tasks in the application 201 that can be dependent on the results generated by the threads 261, 262, . . . , 263. An optimal memory allocation policy can improve the overall performance of the application 201 (e.g., by reducing the time gaps between tasks waiting for results and other tasks completing processing to generate the results).

The requested memory 203 can be in a logical memory space and implemented via a mapping policy 285. For example, the memories 265, 266, . . . , 267 can be mapped (e.g., via the memory controller 116) according to the mapping policy 285 to blocks (e.g., 191, 192, 193, 194) of physical memory in the main memory 124 and/or the secondary random access memory 112.

For example, the memory 265 of the thread 261 can be implemented in the main memory 124 for improved performance in running the thread 261. However, the improved performance in running the thread 261 may not improve the performance of the application 201 in some instances. For example, in some instances, the further processing of the result generated by the thread 261 can be dependent on the results generated by one or more other threads (e.g., 262 or 263); and an early completion of the processing in the thread 261 may result in a period of the result of the thread 261 waiting for other results to become available. In general, it can be a challenge to optimize the policy 285 for the mapping between the memories 265, 266, . . . , 267 and memory blocks (e.g., 191, . . . , 192, . . . , 193, . . . , 194) in the main memory 124 and the secondary random access memory 112 to tune the performances of the threads 261, 262, . . . , 263 in a way to improve the performance of the application 201 as a whole.

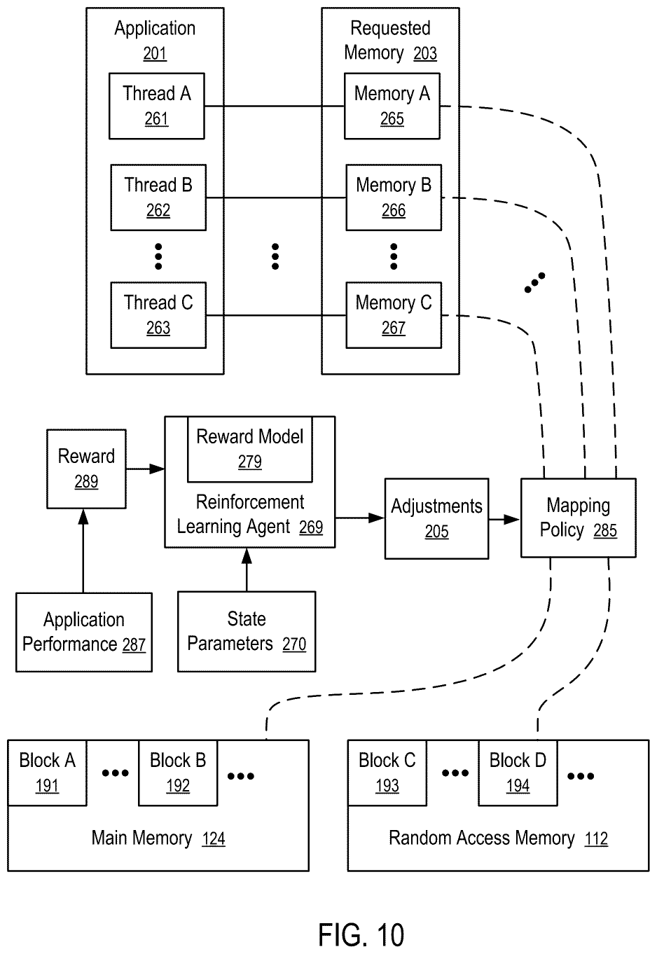

In FIG. 10, a reinforcement learning agent 269 is configured to select adjustments 205 to the mapping policy 285 in view of the current state of the application 201 represented by a set of state parameters 270 (e.g., as in FIG. 13).

For example, the adjustments 205 can include moving the memory (e.g., 265) used by a thread (e.g., 261), or a portion of the memory (e.g., 265), from being mapped to the main memory 124 to being mapped to the secondary random access memory 112; and the adjustments 205 can further include moving the memory (e.g., 266) used by another thread (e.g., 262), or a portion of the memory (e.g., 266), from being mapped to the secondary random access memory 112 to being mapped to the main memory 124.

The reinforcement learning agent 269 has a reward model 279 configured to predict rewards to the reinforcement learning agent 269 for selecting from various candidate adjustments at a time when the application 201 is at a state represented/characterized by a set of state parameters 270. Among the candidate adjustments, the reinforcement learning agent 269 selects the adjustments 205 that, when applied to the mapping policy 285, are expected/predicted according to the reward model 279 to provide the highest reward for the reinforcement learning agent 269.

After the adjustments 205 are applied to the mapping policy 285, the application 201 can continue running in the computing system 100, with memories 265, 266, . . . , 267 of the threads 261, 262, . . . , 263 being mapped, according to the adjusted mapping policy 285, to the main memory 124 and the random access memory 112.

The computing system 100 can measure the performance 287 of the application 201 running using memory 265, 266, . . . , 267 in a way as implemented via the adjusted mapping policy 285. Based on the application performance 287, an actual reward 289 is computed.

For example, the reward 289 can be proportional to the application performance 287. In general, the reward 289 is to increase as the application performance 287 improves; and the reward 289 is to decrease as the application performance 287 deteriorates.

In general, the actual reward 289 is different from the predicted reward generated by the reward model 279 for selecting the adjustments 205 at the state represented by the state parameters 270. Using the actual reward 289 and a reinforcement learning technique, the reinforcement learning agent 269 can adjust the reward model 279 to improve the predictions generated by the reward model 279.

After a period of exploration and learning, the reward model 279 can converge; and the adjustments 205 selected to maximize rewards (e.g., 289) can improve and/or maximize the application performance 287.

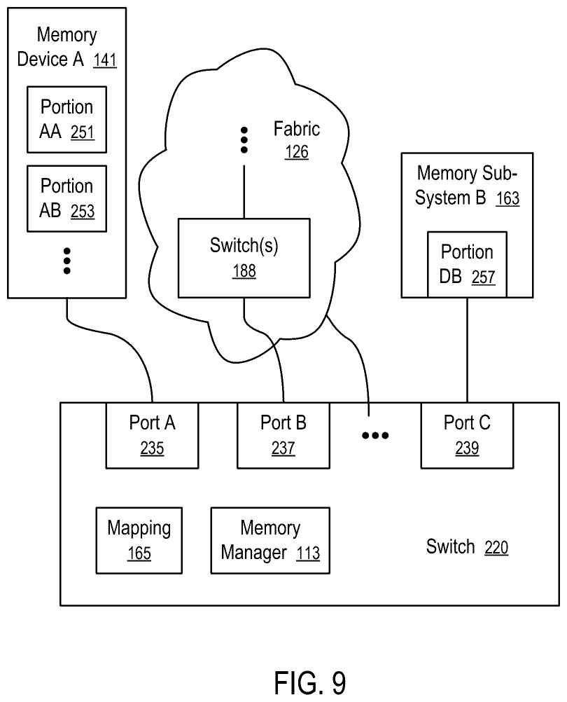

FIG. 11 and FIG. 12 show examples of adjustments to policies of memory allocation according to some embodiments. For example, the adjustments 205 can be configured in a way as illustrated in FIG. 11 and/or FIG. 12.

In FIG. 11, the memories 265, 266, . . . , 267 requested by the threads 261, 262, . . . , 263 running for an application 201 in the host system 102 of a computing system (e.g., 100 of FIG. 1) are divided into two groups. Once group is mapped by the mapping policy 285 in the memory manager 113 to the main memory 124; and the other group is mapped to the random access memory 112 provided via the compute express link fabric 121. The adjustments 205 in FIG. 11 can include changing the membership of one or more memories (e.g., 265, 266) in the groups and thus their mapping destinations.

In FIG. 11, each of the memory 265, 266, . . . , 267 has a contiguous block of memory addresses (e.g., in a logical space) requested by a thread (e.g., 261, 262, or 263) of the application. The memory (e.g., 265, 266, . . . , or 267) is mapped entirely either to the main memory 124 or to the random access memory 112. Optionally, a thread (e.g., 261) can request a plurality of memories (e.g., 265), each having a separate contiguous block of memory addresses (e.g., in a logical memory space). The memory addresses of the plurality of memories (e.g., 265) are not continuous in general. Each of the plurality of memories requested by the thread (e.g., 261) can be mapped entirely either to the main memory 124 or to the random access memory 112.

FIG. 12 shows a technique to split a memory (e.g., 265), requested by a thread (e.g., 261), into portions (e.g., 301 and 303) according to a ratio 305 for mapping to the main memory 124 and the random access memory 112.

For example, the ratio 305 corresponds to the ratio between the size 302 of a portion 301 of the memory 265 and the size 304 of the remaining portion 303 of the memory 265. The portion 301 having the size 302 is mapped to the main memory 124; and the portion 303 having the size 304 is mapped to the random access memory 112. Thus, a contiguous block of memory addresses (e.g., in the logical space) used by the thread (e.g., 261) is split into portions 301 and 303 having discontinuous physical memory addresses across the main memory 124 and the random access memory 112.

When the adjustments 205 changes the ratio 305, the memory 265 is split to a different set of portions 301 and 303 having sizes 302 and 304 configured according to the ratio 305. For example, increasing ratio 305 can increase the size 302 and decrease the size 304; and as a result, the portion 301 being mapped to the main memory 124 increases in its size 302; and the portion 303 being mapped to the random access memory 112 shrinks in its size 304. The overall performance of the memory 265 requested by the thread (e.g., 261) and implemented using a combination of resources from the main memory 124 and the random access memory 112 can increase. When the ratio 305 decreases, the overall performance of the memory 265 can decrease.

In some implementations, the adjustments 205 selected by the reinforcement learning agent 269 can include the adjustment to the ratio (e.g., 305) for one or more of the memories 265, 266, . . . , 267 requested by the threads 261, 262, . . . , 263.

The ratio 305 can be adjusted to increase by one increment, or decrease by one increment, or not changed. The adjustments 205 can include one adjustment option selected for the ratio 305 applied to the memory 265 requested by one thread 261, and another adjustment option to a ratio selected for another thread (e.g., 262).

FIG. 10 to FIG. 12 illustrate an example of mapping a memory 203 requested by threads 261, 262, . . . , 263 of an application 201 to two memory regions (e.g., the main memory 124 and the secondary random access memory 112).

In general, the techniques can be extended to implementations of requested memory 203 using more than two memory regions of different characteristics.

For example, the mapping policy 285 can further include the policies for mapping the portion of the requested memory 203 to the random access memory 112 to specific regions in the random access memory 112. Such regions can include dynamic capacity devices 152, . . . , 154 and/or memory devices 141, 143, . . . , 145 provided via the compute express link fabric 121. The different memory regions in the secondary random access memory 112 can have different cost/performance trade-offs; and adjusting the policy 285 for mapping to specific regions in the random access memory 112 can be used to balance the cost/performance trade-off for running the application 201.

FIG. 13 shows an example of state parameters for a reinforcement learning agent to select parameters used in implementing requested memory according to one embodiment. For example, the state parameters 270 in FIG. 10 can include at least some of the parameters illustrated in FIG. 13.

In FIG. 13, the state parameters 270 include memory usage statistics 271 in a recent time period of operation of the application 201 running in the computing system 100, recent action history 272, current mapping policy parameters 273, and current application performance 274.

The current application performance 274 can include the current performance level of the application 201 (e.g., based on instructions per cycle (IPC) as reported by performance counters of CPU) and/or the cost level of accessing the memory resources.

For example, memory resources provided in different memory regions can have different rates of cost for their usages. The different memory regions can include main memory 124, secondary random access memory 112, different memory devices 141, 143, . . . , 145 used to implement the random access memory 112, and/or different dynamic capacity devices 152, . . . , 154 provided via the compute express link fabric 121.

The actual reward 289 provided to the reinforcement learning agent 269 in FIG. 10 can be based on the performance level of the application 201 running using memory 203 configured via the mapping policy 285 and the cost of the usages of the memory resources such that maximizing the reward to the reinforcement learning agent 269 corresponding to a combined goal of improving the performance of the application 201 and reducing the memory usage cost of running the application 201.

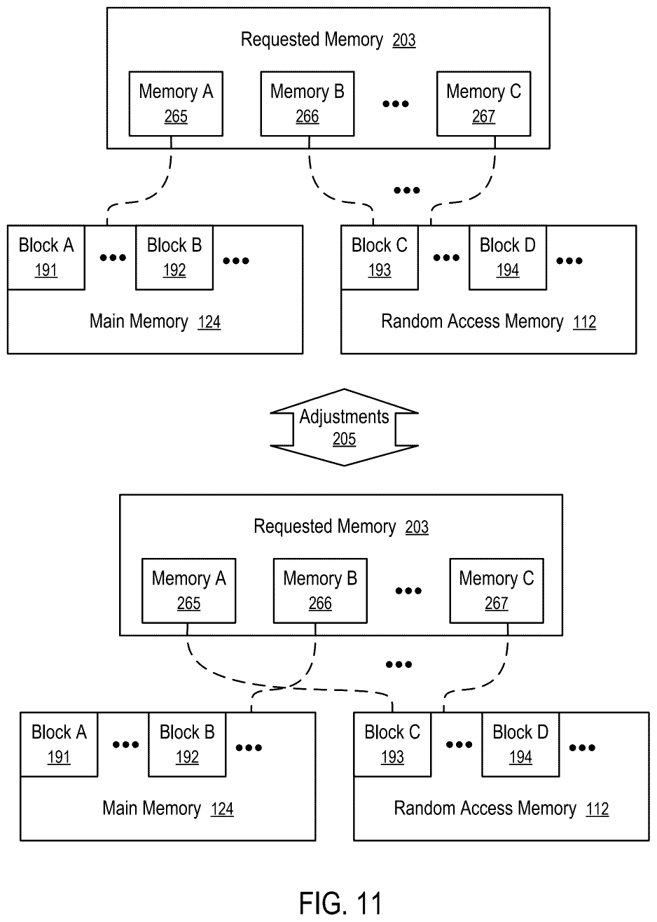

The memory usage statistics 271 can be configured to indicate the memory workloads of the threads 261, 262, . . . , 263 of the application 201. For example, the memory usage statistics 271 can include a set of parameters for each thread (e.g., 261, 262, . . . , 263), as in FIG. 14.

The recent action history 272 can include up to a predetermined number of selections of adjustments (e.g., 205) to parameters 273 of the mapping policy 285 that have been applied to the implementation of requested memory (e.g., 203) using memory of different characteristics (e.g., the main memory 124 and the secondary random access memory 112) to lead the application 201 running in the computing system 100 to the current state as characterized by the state parameters 270.

FIG. 14 shows an example of memory usage statistics that can be used as part of state parameters for implementation of requested memory according to one embodiment. For example, the memory usage statistics 271 in FIG. 13 can include at least some of the parameters illustrated in FIG. 14.

For example, the application 201 can run in the computing system 100 with a plurality of parallel threads 261, 262, . . . , 263. Each of the threads 261, 262, . . . , 263 can request for allocation of one or more memory (e.g., 265, 266, or 267) that can be implemented (e.g., by the memory controller 116) according to the mapping policy 285 using the main memory 124 and the random access memory 112 (and different regions in the random access memory 112). For example, the memory devices 141, 143, . . . , 145 can be different memory regions in the random access memory 112 having different cost/performance trade-offs. For example, the dynamic capacity devices 152, . . . , 154 can be different memory regions in the random access memory 112 having different cost/performance trade-offs.

For a thread (e.g., 321 or 323) of the application 201, the memory manager 113 can measure memory access frequencies 292, memory access counts 293 (e.g., for different types of memory access operations), size 294 of allocated memory (e.g., 265), read-write ratio 295 in accessing memory, and average latency 296.

For example, the memory manager 113 can measure the memory usage statistics 271 for each running thread (e.g., 321) periodically according to a predetermined time interval. The measurement results of the latest time interval can be used as the indication of the current statistics.

For example, the access frequencies 292 can be based on counts of different types of memory access (e.g., read, write, erase) to the heterogeneous memory system containing the main memory 124 and the secondary random access memory 112 during the latest time interval.

For example, the read-write ratio 295 can be based on a ratio between an amount of data read from the heterogeneous memory system and an amount of data written to the heterogeneous memory system during the latest time interval.

For example, the latency 296 can be the average latency of memory access to the heterogeneous memory system during the latest time interval.

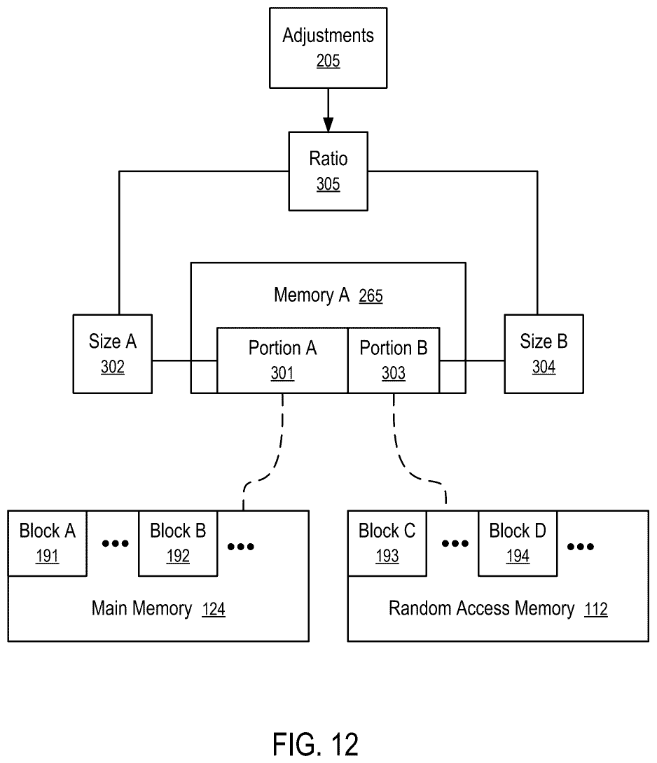

FIG. 15 shows a method to implement memory according to one embodiment. For example, the method of FIG. 15 can be implemented in a computing system 100 of FIG. 1 having a random access memory 112 implemented using the techniques of FIG. 2 to FIG. 9. For example, a memory manager 113 can be configured in the computing system 100 to determine a mapping policy 285 to implement memories 265, 266, . . . , 267 requested by the threads 261, 262, . . . , 263 through incremental adjustments 205 selected using the reinforcement learning techniques of FIG. 10 to FIG. 14.

For example, the computing system 100 can include: a processing device 118; and a plurality of memory regions of different characteristics, such as a main memory 124 connected to the processing device 118 via a memory bus 109 (e.g., a double data rate (DDR) bus); and a secondary random access memory 112 connected to the processing device 118 via a compute express link fabric 121 that is separate from the memory bus 109. The computing system 100 is configured to manage, using a reinforcement learning technique (e.g., implemented in a reinforcement learning agent 269), implementation of memories (e.g., 265, 266, . . . , 267) requested by a plurality of threads (e.g., 261, 262, . . . , 263) running concurrently for an application 201 using memory blocks (e.g., 191, 192, 193, 194) in the plurality of memory regions. Optionally, the plurality of memory regions can include a plurality of dynamic capacity devices 152, . . . , 154 of different characteristics and configured to provide the secondary random access memory 112 over the compute express link (CXL) fabric 121; and the implementation of the memories (e.g., 265, 266, . . . , 267) requested by the plurality of threads (e.g., 261, 262, . . . , 263) can include mapping a first portion of the memories (e.g., 265, 266, . . . , 267) to the main memory 124, mapping a second portion of the memories (e.g., 265, 266, . . . , 267) to the secondary random access memory 112, and mapping a plurality of parts of the second portion to the plurality of dynamic capacity devices 152, . . . , 154 respectively.

For example, the reinforcement learning agent 269 can be configured to select, based a reward model 279 and a current state (e.g., represented by a set of state parameters 270) of the application 201 running in the computing system 100, adjustments 205 to a mapping policy 285 configured to control the implementation of the memories (e.g., 265, 266, . . . , 267) using the memory blocks (e.g., 191, 194) in the main memory 124 and the random access memory 112.

For example, the mapping policy 285 includes a ratio 305 of mapping a memory (e.g., 265), among the memories (e.g., 265, 266, . . . , 267) and requested by a thread (e.g., 261) among the plurality of threads (e.g., 261, 262, . . . , 263), to the plurality of memory regions. The adjustments 205 can include an adjustment to the ratio 305.

For example, the memory manager 113 in the computing system 100 is configured to determine a performance 287 of the application 201 running in the computing system 100 in response to the adjustments 205, calculate a first reward 289 based on the performance 287, and update the reward model 279 based on the first reward 289 in association with the current state (e.g., represented by the state parameters 270) of the application 201.

At block 331, the method of FIG. 15 includes determining a first state (e.g., represented/characterized by parameters 270) of an application 201 having a plurality of threads 261, 262, . . . , 263 running in a computing system 100 having a first memory (e.g., main memory 124) and a second memory (e.g., random access memory 112).

For example, the first memory includes a main memory 124 connected in the computing system 100 to a processing device 118 via a memory bus 109 (e.g., double data rate (DDR) bus); and the second memory includes a secondary random access memory 112 connected in the computing system 100 to the processing device 118 via a compute express link (CXL) fabric 121.

At block 333, the method includes identifying, based on the first state (e.g., represented/characterized by parameters 270) and a reward model 279, first adjustments 205 to parameters of a mapping policy 285 configured to map memories 265, 266, . . . , 267 requested by the threads 261, 262, . . . , 263 to memory blocks (e.g., 191, 193) in the first memory (e.g., main memory 124) and the second memory (e.g., random access memory 112).

At block 335, the method includes determining, after running the application 201 in the computing system 100 under control by the mapping policy 285 as adjusted by the first adjustments 205, a performance 287 of the application 201.

For example, the performance 287 includes a performance level in execution of instructions of the application 201 (e.g., as measured using performance counters in the processing device 118).

Optionally, the performance 287 can further include an indication of a cost level in memory usage of the application 201. For example, different memory regions (e.g., main memory 124, random access memory 112, dynamic capacity devices 152, . . . , 154 in the random access memory 112, and/or memory devices 141, 143, . . . , 145 connected to the compute express link fabric 12 to implement the random access memory 112) can have different rates for their usages; and different ways to implement the memories 265, 266, . . . , 267 used by the threads 261, 262, . . . , 263 can lead to different cost levels in running the application 201.

For example, the parameters of the mapping policy 285 can include a ratio 305 configured to split a memory (e.g., 265) requested by a thread (e.g., 261) into a first portion 301 implemented in the first memory (e.g., main memory 124) and a second portion 303 implemented in the second memory (e.g., random access memory 112). The adjustments 205 can include increasing the ratio 305 by one increment or decreasing the ratio 305 by one increment.

For example, the mapping policy 285 can include membership data configured to separate a first group of memories (e.g., 265) requested by a first subset of the plurality of threads 261, 262, . . . , 263 and a second group of memories (e.g., 266) requested by a second of the plurality of threads 261, 262, . . . , 263, where the first group of memories (e.g., 265) are mapped to the first memory (e.g., main memory 124) and the second group of memories (e.g., 266) to the second memory (e.g., random access memory 112).

For example, the mapping policy 285 can include parameters configured to determine how a portion of the memories 265, 266, . . . , 267 requested by the threads 261, 262, . . . , 263 are mapped to different memory regions within the second memory (e.g., random access memory 112), such as different devices among the dynamic capacity devices 152, . . . , 154 and/or the memory devices 141, 143, . . . , 145.

For example, the dynamic capacity devices 152, . . . , 154 can be offered via the compute express link fabric 121 with different trade-offs in cost and performance and implemented using a plurality of memory devices 141, 143, . . . , 145 that are connected to the compute express link fabric 121 and that are of different characteristics in latency, bandwidth, capacity, cost, etc.

At block 337, the method includes computing a first reward 289 based on the performance 287 of the application 201.

Optionally, the first reward 289 can be based on both the performance level in the execution of the instructions of the application 201 and the cost level in the memory usage.

For example, the reward 289 can include a first component that is proportional to the performance level in the execution of the instructions of the application 201. The reward 289 can include a second component that is proportional to a negative version of the cost level in the memory usage. The reward 289 can be a weighted average of the first component and the second component, where the weights are adjustable according to the priority to increase the performance level in the execution of the instructions of the application 201 and the priority to decrease the cost level in the memory usage.

At block 339, the method includes updating, based on the first reward 289, the reward model 279 configured to predict at least a second reward for selecting, when the application 201 is at the first state (e.g., represented/characterized by parameters 270), the first adjustments 205.

For example, before the updating at block 339, the reward model 279 is configured to predict a second reward, different from the first reward 289, for selecting the adjustments 205 when the application 201 is in the state represented by the state parameters 270. The updating at block 339 includes improving, in view of the first reward 289, a reward predicted by the reward model 279 for selecting the adjustments 205 when the application 201 is in the state represented by the state parameters 270.

As the prediction accuracy of the reward model 279 improves through machine learning from the actual rewards (e.g., 289), the reinforcement learning agent 269 can select adjustments (e.g., 205) from candidates such that the selected adjustments (e.g., 205) are expected to provide the highest reward according to the predictions made using the reward model 279. Maximizing the reward 289 to the reinforcement learning agent 269 corresponds to improving the performance of the application 201 and/or reducing the cost of running the application 201.

The machine learning of the reward model 279 can continue and/or be performed in regular interval to adapt to the changing workload patterns of the application 201.

At least some embodiments disclosed herein include techniques to control how concurrent threads (e.g., 261, 262, . . . , 263) running for an application (e.g., 201) are configured for improved performance of running the application (e.g., 201) in a computing system (e.g., 100 in FIG. 1).

For example, the computing system 100 of FIG. 1 has a heterogeneous memory system, including a main memory 124 connected to a processing device 118 via a memory bus 109 (e.g., a double data rate (DDR) bus) and a secondary random access memory 112 connected to the processing device 118 via a compute express link (CXL) fabric 121. The processing device 118 can have a plurality of cores operable to run a plurality of threads (e.g., 261, 262, . . . , 263) in parallel for an application (e.g., 201).

In general, the application (e.g., 201) can compete with other applications and/or routines running in the computing system 100 for resources, such as memory allocated from the main memory 124 and/or the secondary random access memory 112; and the plurality of threads (e.g., 261, 262, . . . , 263) can compete with each other for resources. Thus, it can be a challenge to design a policy to control the configuration of starting threads (e.g., 261, 262, . . . , 263) of an application 201 and/or the distribution of resources among the threads (e.g., 261, 262, . . . , 263).

An intelligent module can be configured to monitor and analyze the memory access patterns of the computations of the application to construct threads of parallel computations to best utilize the available computing hardware, such as the processing device 118 (e.g., CPU, CPU cores, GPUs, GPU cores, AI accelerators), and memory resources (e.g., main memory 124, secondary random access memory 112).

For example, the intelligent module can partition available memory (e.g., a portion of the main memory 124 and the secondary random access memory 112 that can be allocated to the application 201) for distribution to the threads (e.g., 261, 262, . . . , 263) to optimize the overall performance of the application 201.

For example, the intelligent module can adjust the number of concurrent threads (e.g., 261, 262, . . . , 263) instantiated for the application 201 to optimize the overall performance of the application 201.

For example, the intelligent module can be implemented in a reinforcement learning agent configured to learn rewards to adjust the thread configuration of the application 201 and/or memory distribution to the threads (e.g., 261, 262, . . . , 263) of the application 201.

For example, based on a current state of the computing system 100 running the application 201, the reinforcement learning agent can select increasing the number of concurrent threads (e.g., 261, 262, . . . , 263) running for the application 201, or decreasing the number, or maintaining the same number of concurrent threads (e.g., 261, 262, . . . , 263).

Alternatively, or in combination, the reinforcement learning agent can change, based on the current state of the computing system 100 running the application 201, a ratio of distributing memory available to the application 201 to the concurrent threads (e.g., 261, 262, . . . , 263).

After the adjustments to the thread configuration of the application are implemented, the computing system 100 can determine the performance 287 of the application 201. A reward can be provided to the reinforcement learning agent for selecting the adjustments at the corresponding state of the computing system 100 running the application 201.

After a period of exploration and learning, the reward model of the reinforcement learning agent can converge; and the reinforcement learning agent can select adjustments, from candidates, that maximize expected rewards to the reinforcement learning agent as predicted using the reward model. Maximizing expected rewards to the reinforcement learning agent can lead to an improved or optimized performance 287 of the application 201 running in the computing system 100.

As the workload of the application 201 and/or the computing system 100 changes, the reinforcement learning agent can continue learning rewards provided as a result of implementing the adjustments selected by the reinforcement learning agent. Thus, the reward model can adapt to the changing workload of the application 201 and/or the computing system 100 to improve and/or optimize the performance 287 of the application 201.

Optionally, the techniques to intelligently adjust the thread configuration of the application 201 can be used with the techniques to intelligently adjust the mapping policy 285 used to implement the memories (e.g., 265, 266, . . . , 267) used by the concurrently running threads 261, 262, . . . , 263 of the application 201.

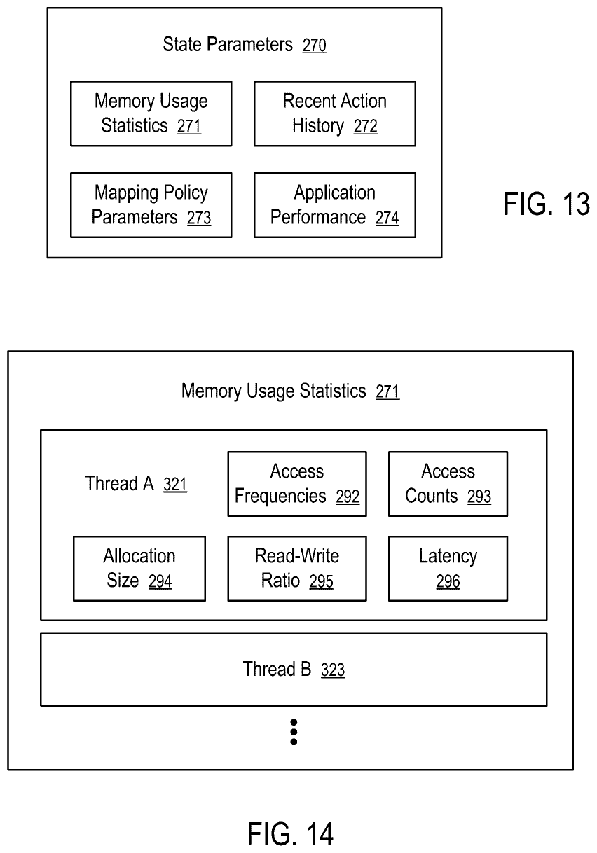

FIG. 16 illustrates a reinforcement learning technique to manage the configuration of running concurrent threads for an application according to one embodiment. For example, the technique of FIG. 16 can be used in a computing system 100 running an application 201 that can have an adjustable configuration for instantiating concurrently running multiple threads (e.g., 261, 262, . . . , 263).

In FIG. 16, the application 201 has an adjustable configuration for instantiating concurrent threads. A reinforcement learning agent 268 is configured to select, based on a current state of the computing system 100 running the application 201, an adjustment 207 to the configuration to cause a thread configuration change 206.

For example, the thread configuration change 206 can cause the application 201 to instantiate less concurrently running threads 261, 262, . . . , 263, or more threads 261, 262, . . . , 263, and 264.

For example, the adjustment 207 can be selected from a predetermined number of candidates, such as increasing or decreasing the number of concurrently running threads by one, or two (or more), or maintaining the current number of concurrently running threads.

The current state of the computing system 100 running the application 201 can be represented by, or characterized by, a set of state parameters 280.

After the implementation of the adjustment 207, the computing system 100 can measure the performance 287 of the application 201 running in the computing system 100 (e.g., in a way similar to the measuring of the performance 287 after the adjustments 205 to the mapping policy 285 in FIG. 10).

Based on the application performance 287, a reward 288 can be computed and provided to the reinforcement learning agent 268 to update the reward model 278 of the reinforcement learning agent 268.

The reward model 278 can be used by the reinforcement learning agent 268 to predict expected rewards to the reinforcement learning agent 268 in selecting various adjustments (e.g., 207) at the state represented by the state parameters 280.

After a period of exploration and learning, the reward model 278 can converge. The reinforcement learning agent 268 can use the reward model 278 to select the adjustment 207. For example, for each of the adjustment candidates that may be selected by the reinforcement learning agent 268, the reward model 278 can be used to predict the reward that the reinforcement learning agent 268 can expect by selecting the candidate at the current state represented by the state parameters 280. Among the candidates, the reinforcement learning agent 268 can select, as the adjustment 207, the candidate that can cause the reinforcement learning agent 268 to receive the largest reward according to the predictions of the reward model 278. The decisions to select adjustments (e.g., 207) to maximize rewards (e.g., 288) to the reinforcement learning agent 268 can lead to the improvement and/or optimization of the performance 287 of the application 201.

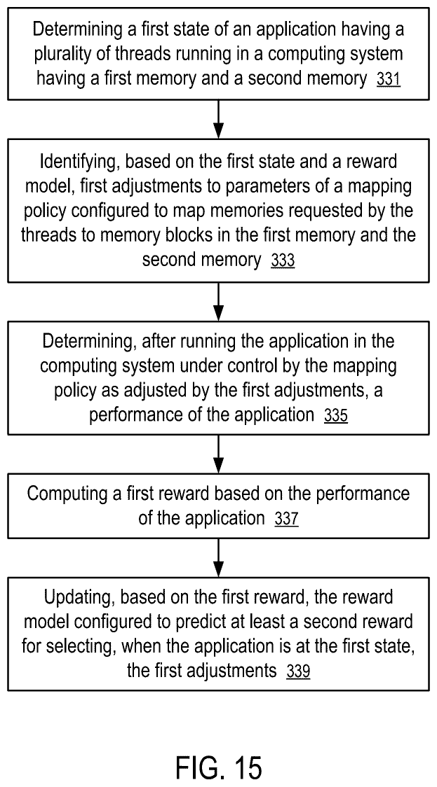

Optionally, the techniques of FIG. 10 and FIG. 16 can be used in combination, as in FIG. 17.

FIG. 17 shows a method to optimize performance of an application according to one embodiment. For example, the method of FIG. 17 can be used in a computing system 100 having a heterogeneous memory system to run an application 201 having an adjustable configuration for instantiating concurrently running multiple threads (e.g., 261, 262, . . . , 263).

At block 351, the method of FIG. 17 includes determining, by the computing system 100, state parameters 280 representative of a current state of an application 201 running in the computing system 100.

At block 353, the method includes determining, based on the current state, an adjustment 207 to a thread configuration for the application 201.

For example, the adjustment 207 can include a change 206 in the thread configuration to increase or decrease the number of threads instantiated to run concurrently in the computing system 100 as in FIG. 16.

At block 355, the method includes running threads (e.g., 261, 262, . . . ) for the application 201 according to the adjusted thread configuration.

At block 357, the method includes adjusting a mapping policy 285 for implementation of memories (e.g., 265, 266, . . . ) requested by the threads (e.g., 261, 262, . . . ).

After a few iterations of adjusting the mapping policy 285 to improve the performance 287 of the application 201, the method of FIG. 17 can continue with the operation at block 351 to determine a next adjustment to the thread configuration at block 353.

For example, the adjusting at block 357 can be performed using reinforcement learning techniques discussed in connection with FIG. 10 to FIG. 15.

For example, the determining of the adjustment at block 353 can be performed using the technique discussed in connection with FIG. 16.

In some implementations, separate reinforcement learning agents 268 and 269 are configured to select adjustments (e.g., 207, 205) to the thread configuration of the application 201 and the mapping policy 285.

For example, the reinforcement learning agent 269 can be configured to operate in, or in connection with, the memory controller 116 in the host system 102. The reinforcement learning agent 269 can perform the selection of adjustments 205 to the mapping policy 285 within internal details about tasks being processed in the application 201 and/or by the threads 261, 262, . . . , 263.

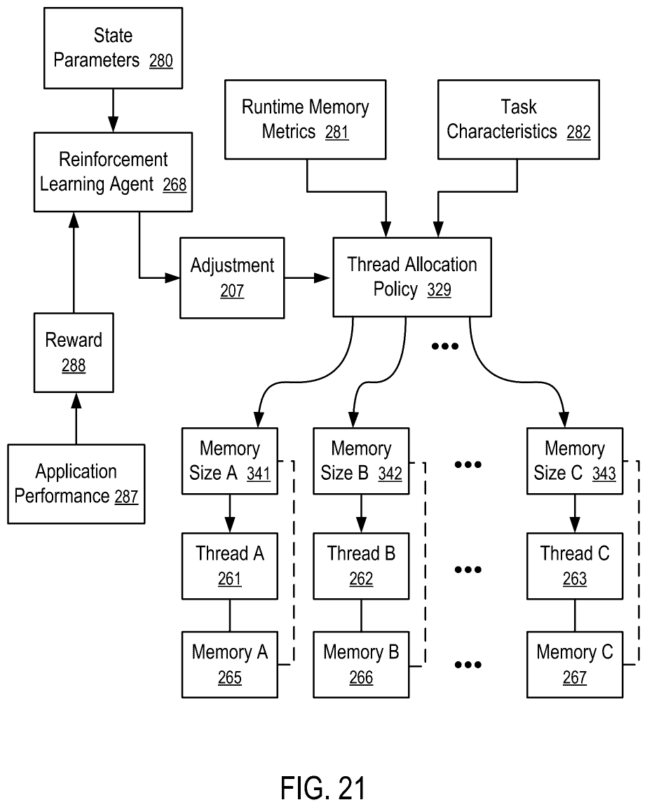

Optionally, the reinforcement learning agent 268 can be configured as part of, or a service to, the application 201 running in the host system 102. The reinforcement learning agent 268 can obtain statistics about tasks to be processed by the threads 261, 262, . . . , 263, and/or milestones achieved in the application 201 to be more effective in optimizing the thread configuration via adjustments 207. For example, the reinforcement learning agent 268 can adjust, based on the state parameters that include information about the tasks to be processed by the application 201, not only the number of threads 261, 262, . . . , to be instantiated (e.g., as in FIG. 16), but also how the memory available to the application 201 is to be divided for use by the threads 261, 262, . . . , to be instantiated (e.g., as in FIG. 16) for the application 201 to process the tasks (e.g., as in FIG. 21).

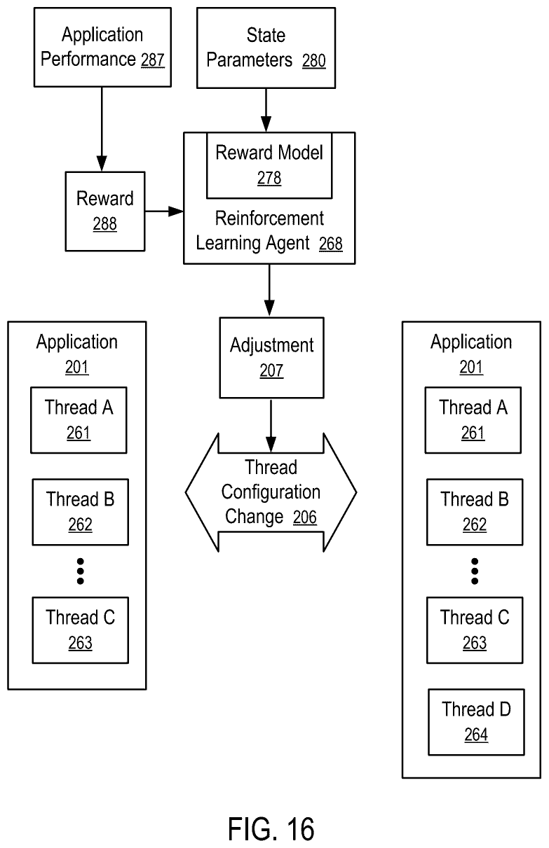

Optionally, both the reinforcement learning agents 268 and 269 are configured as system services for the application 201. The application 201 can use an application programming interface to provide task information to the reinforcement learning agents 268 and 269 to better identify the state of the application 201 running in the computing device. For example, the application 201 can be configured to provide task characteristics 282 and/or runtime memory metrics 281 as in FIG. 18 to identify a current state of the application 201.

FIG. 18 shows an example of state parameters for a reinforcement learning agent to select adjustments to a thread configuration of an application according to one embodiment. For example, the state parameters 280 used by the reinforcement learning agent 268 in FIG. 16 can include at least some of the parameters illustrated in FIG. 18. Optionally, the state parameters 270 used by the reinforcement learning agent 268 in FIG. 10 can also include at least some of the parameters illustrated in FIG. 18.

In FIG. 18, the state parameters 280 can include runtime memory metrics 281, task characteristics 282, current thread configuration 283, and current application performance 284.

The current thread configuration 283 can specify the number of concurrent threads (e.g., 261, 262, . . . ) that can be instantiated for running in parallel in the computing system 100 for the application 201. Further, the current thread configuration 283 can specify how memory resources are distributed to the concurrent threads (e.g., 261, 262, . . . ) (e.g., as in FIG. 21).

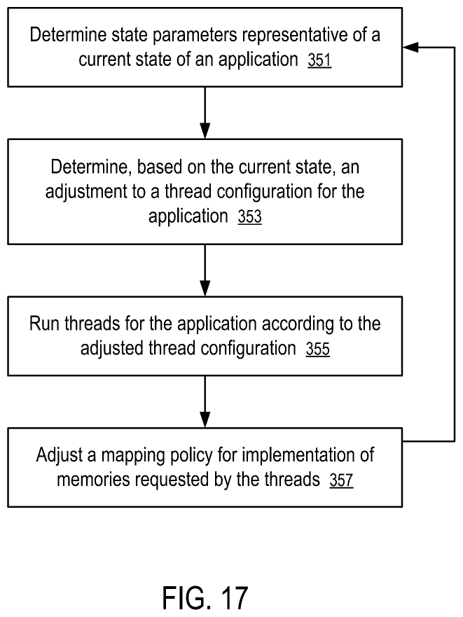

The runtime memory metrics 281 can be configured to identify the current memory resources available for running threads (e.g., 261, 262, . . . ), their current patterns of usages by the threads (e.g., 261, 262, . . . ), and their current performance levels in servicing memory access requests from the threads (e.g., 261, 262, . . . ), as further illustrated in FIG. 19.

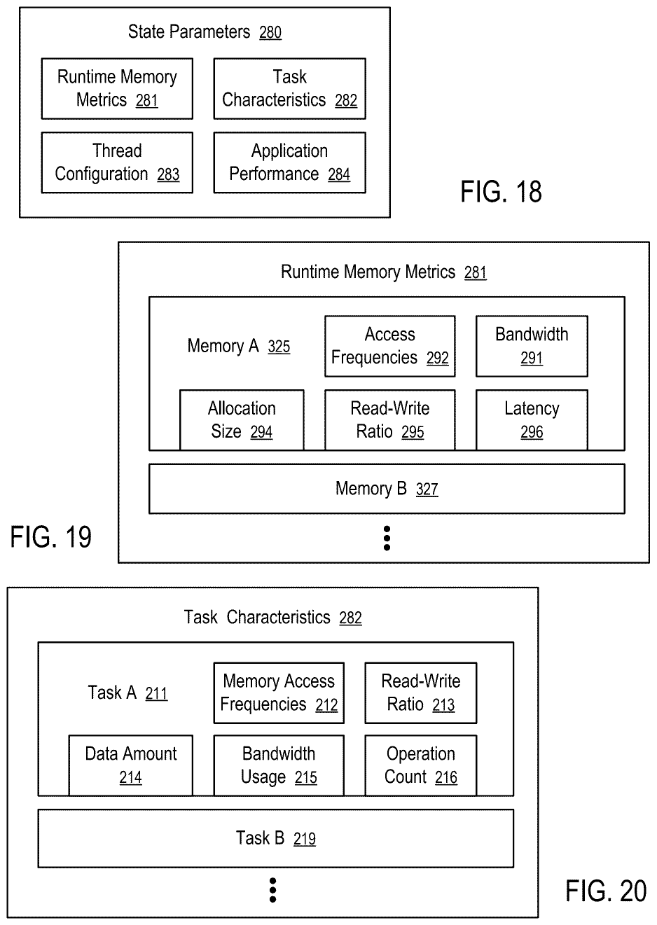

The task characteristics 282 can be configured to identify the workloads of the application 201 to be processed by thread to be instantiated according to the thread configuration 283. For example, the task characteristics 282 can identify (e.g., as in FIG. 20) the past memory access patterns of the tasks to be assigned to the threads to be instantiated for processing. For example, the past memory access patterns can include memory access frequencies of a thread in processing a task in the past, memory bandwidth usages for the processing of the task, read-write ratio in memory access for the processing of the task, etc. For example, the workload for a task to be assigned to a thread for processing can include an amount of data of to be processed by the thread, a count of operations to be performed by the thread in completing the task in the past, etc.

The application performance 284 in the state parameters 280 in FIG. 18 can be configured in a way similar to the application performance 274 in the state parameter 270 in FIG. 13. For example, the current application performance 284 can include the current performance level of the application 201 (e.g., based on instructions per cycle (IPC) as reported by performance counters of CPU, GPU, and/or AI accelerator) and/or the cost level of accessing the memory resources.

FIG. 19 shows an example of runtime memory metrics that can be used as part of state parameters for control running thread for an application according to one embodiment. For example, the runtime memory metrics 281 in FIG. 18 can include at least some of the parameters illustrated in FIG. 19.

For example, the application 201 can run in the computing system 100 have a plurality of memories (e.g., 265, 266) allocated for use by the threads (e.g., 261, 262, . . . ) running for the application 201. The runtime memory metrics 281 can identify the pattern of usages of the memories (e.g., 265, 266).

For a memory 325 (e.g., used by a thread 261 or 262) of the application 201, the memory manager 113 can measure memory access frequencies 292, memory bandwidth 291, size 294 of allocated memory (e.g., 265), read-write ratio 295 in accessing memory, and average latency 296.

For example, the memory manager 113 can measure the memory metrics 281 for memory (e.g., 325, or 327) used by a thread (e.g., 261 or 262) for the duration of the execution of a thread (e.g., 261 or 262).

For example, the access frequencies 292 can be based on counts of different types of memory access (e.g., read, write, erase) to the heterogeneous memory system containing the main memory 124 and the secondary random access memory 112 during the execution of a thread (e.g., 261 or 262) using the memory 325.

For example, the read-write ratio 295 can be based on a ratio between an amount of data read from the heterogeneous memory system and an amount of data written to the heterogeneous memory system during the execution of a thread (e.g., 261 or 262) using the memory 325.

For example, the latency 296 can be the average latency of memory access to the heterogeneous memory system during the execution of a thread (e.g., 261 or 262) using the memory 325.

FIG. 20 shows an example of task characteristics that can be used as part of state parameters for control running thread for an application according to one embodiment. For example, the task characteristics 282 in FIG. 18 can include at least some of the parameters illustrated in FIG. 20.

For example, the application 201 can have a plurality of tasks that can be assigned to threads (e.g., 261, 262, . . . ) for processing. Each of the tasks (e.g., 211, or 219) can have a set of parameters that can be used to characterize the workload of the task to be assigned to a thread (e.g., 261 or 262). For example, the parameters can be statistical data and/or measurements obtained from executing the same task, or a similar task, in the past during one or more prior runs of the application 201.

For a task 211 (e.g., previously performed by a thread 261 or 262) of the application 201, the application 201 and/or the memory manager 113 can measure memory access frequencies 212, read-write ratio 213 in accessing memory, amount of data 214 processed by the thread, usage 215 of memory bandwidth, count of operations performed by the thread, etc.

For example, the task characteristics 282 can include the tasks 211, 219 that are currently assigned to, or about to be assigned to, threads (e.g., 261, 262, . . . ). Other tasks can be excluded from the state parameter 280 used for selecting an adjustment 207 to the current thread configuration 283 used to control the processing of a next set of tasks (e.g., 211, 219).

For example, the application 201 can measure the memory access and computations performed during an instance of the execution of a task 211; and an average of the measurements obtained over a plurality of instances of the execution of the task 211 can be as the characteristics of the task 211.

For example, the memory access frequencies 212 can be based on average counts of different types of memory access (e.g., read, write, erase) to the heterogeneous memory system containing the main memory 124 and the secondary random access memory 112 during the computing system 100 performing the task 211 in one or more prior runs of the application 201.

For example, the read-write ratio 213 can be based on an average of the ratio between an amount of data read from the heterogeneous memory system and an amount of data written to the heterogeneous memory system during the computing system 100 performing the task 211 in one or more prior runs of the application 201.

For example, the data amount 214 can be a measure of data (e.g., weight data of artificial neural network) being applied in performing the task 211.

For example, the bandwidth usage 215 can be based on an average of memory bandwidth usages during the computing system 100 performing the task 211 in one or more prior runs of the application 201.

For example, the operation count 216 can be an average of the count of operations performed by the computing system 100 in one or more prior runs of the application 201.

Based on the task characteristics 282 and the state parameters 280, the reinforcement learning agent 268 can adjust the thread configuration 283 to change the number of concurrently running threads (e.g., 261, 262, . . . ) of the application 201, but also task assignments to threads and resource allocations for the threads, as illustrated in FIG. 21.

FIG. 21 shows a technique to control memory allocations of concurrent threads of an application according to one embodiment.

In FIG. 21, the runtime memory metrics 281 can identify an amount of memory resources that can be used by the threads 261, 262, . . . , 263. For example, the sizes of the memories 265, 266, . . . , 267 currently being used for threads 261, 262, . . . , 263 running in the computing system 100 can be summed to obtain an estimate of a total amount of memory that can be used by the threads of the computing system 100.

A thread allocation policy 329 can be used to assign a next set of tasks (e.g., 211, 219, . . . ) as in the task characteristics 282 to a next set of threads to be instantiated to perform the respective tasks (e.g., 211, 219, . . . ). The thread allocation policy 329 can be configured to match the workload and/or memory demand of the tasks (e.g., 211, 219, . . . ) with the available memory resources. The reinforcement learning agent 268 can select adjustment 207 to the thread allocation policy 329 to determine the memory sizes 341, 342, . . . , 343 for the allocation of memories 265, 266, . . . , 267 for the thread 261, 262, . . . , 263 to be instantiated for performing the next set of tasks. Thus, memory sizes 341, 342, . . . , 343 coordinate the memory demands of the threads 261, 262, . . . , 263 for improving the application performance 287 of the application 201 through maximizing the reward 288.

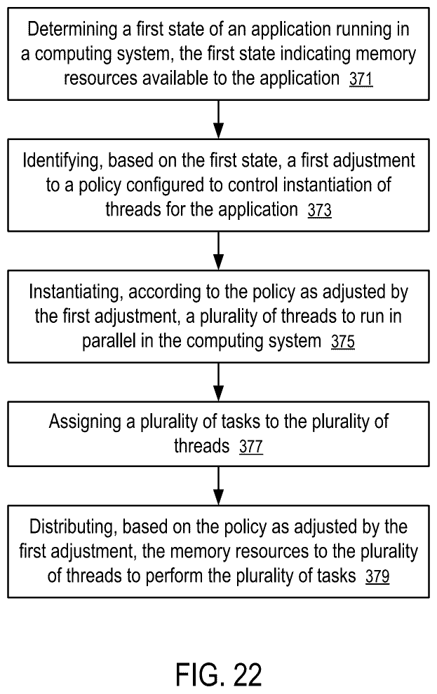

FIG. 22 shows a method to control running concurrent threads for an application according to one embodiment. For example, the method of FIG. 22 can be implemented in a computing system 100 of FIG. 1 having a random access memory 112 implemented using the techniques of FIG. 2 to FIG. 9. For example, a memory manager 113 can be configured in the computing system 100 to determine a thread configuration 283 to control the use of concurrent threads 261, 262, . . . , to perform tasks of an application using the reinforcement learning techniques of FIG. 16 to FIG. 21. Optionally, the memory manager 113 can further determine a mapping policy 285 to implement memories 265, 266, . . . , 267 used by the concurrently running threads 261, 262, . . . , using the reinforcement learning techniques of FIG. 10 to FIG. 14.

For example, the computing system 100 can have a processing device 118 operable to run a plurality of threads in parallel; and a heterogeneous memory system having memory regions of different characteristics, such as a main memory 124 connected to the processing device 118 via a memory bus 109 (e.g., a double data rate (DDR) bus) and a secondary random access memory 112 connected to the processing device 118 via a compute express link (CXL) fabric. The computing system 100 is configured to manage, using a reinforcement learning technique (e.g., implemented in a reinforcement learning agent 268), a policy to control a configuration 283 of threads (e.g., 261, 262, . . . ) running in parallel for an application 201.

For example, the thread configuration 283 can control how many threads are instantiated for concurrent operations of the application 201. The thread configuration 283 can further control a distribution of memory resources to threads 261, 262, . . . , running in parallel for the application 201. For example, based on the total sizes of memory currently available to the application 201, the thread configuration 283 can include a thread allocation policy 329 to determine the sizes 341, 342, . . . , 343 of memories 265, 266, . . . , 267 allocated to the concurrent threads 261, 262, . . . , 263 of the application 201.

For example, the reinforcement learning agent 268 is configured with a reward model 278 operable to predict a reward to the agent 268 if the agent selects an adjustment 207 to the thread configuration 283 and/or the thread allocation policy 329 when the application 201 is in a current state represented by or characterized by state parameters 280. From a set of candidates, the reinforcement learning agent 268 can select an adjustment 207 that is predicted, according to the reward model 278, to provide the largest reward to the reinforcement learning agent 268.

For example, the state parameters 280 can include runtime memory metrics 281 as illustrated in FIG. 19 and characteristics 282 of tasks to be performed by threads to be instantiated for the application 201 as illustrated in FIG. 20.

At block 371, the method of FIG. 22 includes determining a first state (e.g., represented by state parameters 280) of an application 201 running in a computing system 100. For example, the first state (e.g., represented by state parameters 280) can indicate memory resources available to the application 201. Further, the first state (e.g., represented by state parameters 280) can indicate memory workloads and/or computation workloads of a next set of tasks to be performed by threads running for the application 201.

At block 373, the method includes identifying, based on the first state, a first adjustment 207 to a policy (e.g., thread allocation 329 and/or thread configuration 283) configured to control instantiation of threads for the application 201.

At block 375, the method includes instantiating, according to the policy (e.g., thread allocation 329 and/or thread configuration 283) as adjusted by the first adjustment 207, a plurality of threads (e.g., 261, 262, . . . ) to run in parallel in the computing system 100.

At block 377, the method includes assigning a plurality of tasks (e.g., 211, 219) to the plurality of threads (e.g., 261, 262).

At block 379, the method includes distributing, based on the policy as adjusted by the first adjustment, the memory resources to the plurality of threads (e.g., 261, 262) to perform the plurality of tasks (e.g., 211, 219).

For example, the first adjustment 207 can change a count of the plurality of threads (e.g., 261, 262, . . . ) to run in parallel for the application 201, as in FIG. 16.

For example, the first adjustment 207 can change a ratio of distributing the memory resources (e.g., memories 265, 266, . . . ) to the plurality of threads (e.g., 261, 262, . . . ), as in FIG. 21.

For example, the identifying of the first adjustment 207 at block 373 can be further based on a reward model 278; and the method of FIG. 22 can further include: determining, after completion of the plurality of tasks (e.g., 211, 219), a performance 287 of the application 201; and computing a first reward 288 based on the performance 287 of the application 201; and updating, based on the first reward 288, the reward model 278 to improve its predictions.

For example, the performance 287 of the application 201 can include a performance level in execution of instructions of the application 201 (e.g., as measured using one or more performance counters in a processing device 118 of the computing system 100). Optionally, the performance 287 of the application 201 can further include a cost level in memory usage of the application 201; and the first reward 288 can be based on both the performance level in the execution of the instructions of the application 201 and the cost level in the memory usage.

For example, the determining of the first state at block 371 can include determining a set of state parameters 280 configured to represent the first state. The state parameters 280 can include runtime memory metrics 281 of memories (e.g., 325, . . . , 327) used by threads running for the application 201, as in illustrated in FIG. 19. Further, the state parameters 280 can include task characteristics 282 of at least the plurality of tasks (e.g., 211, 219) to be performed next. Optionally, the state parameters 280 can include task characteristics 282 of tasks that are currently in progress, or just completed.

A non-transitory computer storage medium can be used to store instructions programmed to implement a memory manager 113 configured to perform operations discussed above in connection with the main memory 124 and the random access memory 112 in a secondary tier memory of a host processor 106, including the operations of the reinforcement learning agent 269. When the instructions are executed by the processing device 118, the controller 115, the processing device 117, the controller 122, and/or the compute express link switches (e.g., 220; 221, 223, . . . , 225), the instructions cause the computing system 100 to perform the methods discussed above.

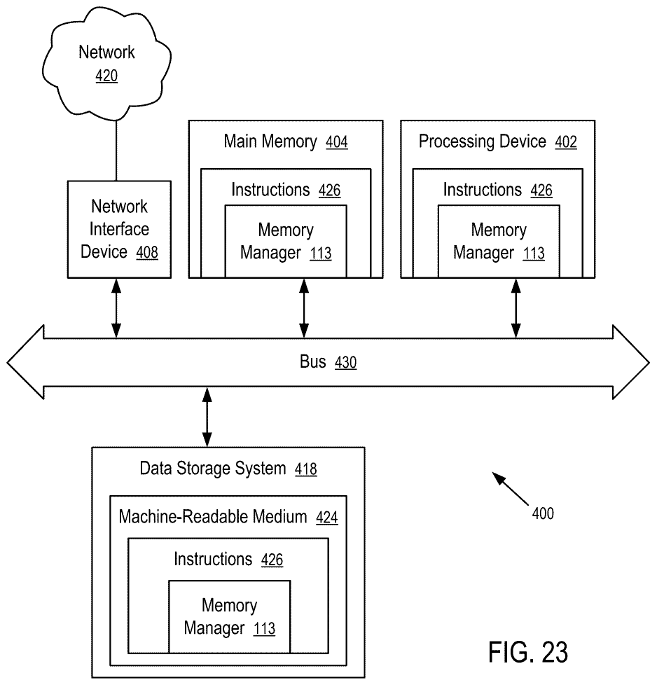

FIG. 23 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of memory managers 113 (e.g., to execute instructions to perform operations corresponding to the memory managers 113 described with reference to FIG. 1-22). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the memory managers 113 described with reference to FIG. 1-22. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
determining a first state of an application running in a computing system, the first state indicating memory resources available to the application;
identifying, based on the first state, a first adjustment to a policy configured to control instantiation of threads for the application;
instantiating, according to the policy as adjusted by the first adjustment, a plurality of threads to run in parallel in the computing system; and
assigning a plurality of tasks to the plurality of threads.

2. The method of claim 1, further comprising:
distributing, based on the policy as adjusted by the first adjustment, the memory resources to the plurality of threads to perform the plurality of tasks;
wherein the first adjustment changes a count of the plurality of threads to run in parallel for the application.

3. The method of claim 1, wherein the first adjustment changes a ratio of distributing the memory resources to the plurality of threads.

4. The method of claim 1, wherein the identifying is further based on a reward model; and the method further comprises:
determining, after completion of the plurality of tasks, a performance of the application; and
computing a first reward based on the performance of the application; and
updating, based on the first reward, the reward model.

5. The method of claim 4, wherein the determining of the first state includes determining a set of state parameters configured to represent the first state; and wherein the state parameters include runtime memory metrics of memories used by threads running for the application.

6. The method of claim 5, wherein the state parameters further include task characteristics of at least the plurality of tasks.

7. The method of claim 4, wherein the performance includes a performance level in execution of instructions of the application.

8. The method of claim 7, wherein the performance level is measured based on one or more performance counters in a processing device of the computing system.

9. The method of claim 8, wherein the performance further includes a cost level in memory usage of the application.

10. The method of claim 9, wherein the first reward is based on the performance level in the execution of the instructions of the application and the cost level in the memory usage.

11. A system, comprising:
a processing device; and
a heterogeneous memory system having memory regions of different characteristics;
wherein the system is configured to manage a policy to control a configuration of threads running in parallel for an application.

12. The system of claim 11, wherein the plurality of memory regions include:
a main memory connected to the processing device via a memory bus; and
a secondary random access memory connected to the processing device via a compute express link fabric that is separate from the memory bus.

13. The system of claim 12, wherein the configuration controls a count of threads instantiated for concurrent operations of the application.

14. The system of claim 13, wherein the configuration controls a distribution of memory resources to threads running in parallel for the application.

15. The system of claim 14, wherein a reinforcement learning technique is implemented in a reinforcement learning agent having a reward model and configured to determine a current state of the application represented by a plurality of state parameters and to determine an adjustment to the policy based on the reward model and the current state.

16. The system of claim 15, wherein the state parameters include runtime memory metrics and characteristics of tasks to be performed by threads to be instantiated for the application.

17. A non-transitory computer storage medium storing instructions which, when executed by a computing system, cause the computing system to perform a method, comprising:
determining an adjustment to a policy configured to control running threads for an application;
measuring a performance of the application running with treads configured according to the policy as adjusted by the adjustment;
computing a first reward based on the performance; and
updating, based on the first reward, the reward model.

18. The non-transitory computer storage medium of claim 17, wherein the policy controls a count of threads instantiated for parallel operations of the application.

19. The non-transitory computer storage medium of claim 18, wherein the policy further controls a ratio of distributing memory resources available to the application to threads running in parallel for the application.

20. The non-transitory computer storage medium of claim 19, wherein the adjustment is determined based on a set of state parameters configured to represent a current state of the application running in the computing system; the state parameters include runtime memory metrics of memory currently being used by the application and characteristics of at least a next set of tasks to be assigned to threads.
